(19) United States
(12) Patent Application Publication
(10) Pub. No.: US 2009/0267879 A1
(43) Pub. Date: Oct. 29, 2009

(54) LIQUID CRYSTAL DISPLAY DEVICE

(75) Inventor: Takeshi Masuda, Ikoma-shi (JP)

Correspondence Address: SHARP KABUSHIKI KAISHA;C/O KEATING & BENNETT, LLP, 1800 Alexander Bell Drive, SUITE 200, Reston, VA, 20191, US

(73) Assignee: SHARP KABUSHIKI KAISHA, Osaka-shi, Osaka (JP)

(21) Appl. No.: 12/441,971

(22) PCT Filed: Jun. 8, 2007
(86) PCT No.: PCT/JP2007/061624

§ 371 Date: Mar. 19, 2009

(30) Foreign Application Priority Data
Oct. 27, 2006 (JP) 2006-293235

(51) Int. Cl. G09G 3/36; G02F 1/13357

(52) U.S. Cl. 345/88; 349/68; 345/102

(57) ABSTRACT

A liquid crystal display device includes a liquid crystal display panel for performing color display, and a backlight unit that includes RGB-LEDs and white LEDs. The RGB-LEDs and the white LEDs are different from each other in color difference between a white point and each primary color point in the respective images displayed on the liquid crystal display panel when the RGB-LEDs and the white LEDs are individually turned on. Further, the light source includes a backlight control section arranged to select one type of the light-emitting elements to emit light, so that the color difference in an image display on the liquid crystal display panel is smaller when the image has a higher lightness.

### BACKGROUND OF THE INVENTION

1. Field of the Invention

The present invention relates to a liquid crystal display device including a liquid crystal panel and a backlight unit and, in particular, to a liquid crystal display device in which illumination light from the backlight unit is controlled in accordance with an image to be displayed.

2. Description of the Related Art

Liquid crystal display devices have features such as flatness, low power consumption, and high resolution. Since the screen size of liquid crystal display devices has become larger due to developments in production technology, an increasing number of liquid crystal display devices are widely used in the field of televisions, in which cathode ray tube (CRT) display devices have conventionally been dominant.

However, the following problem has been pointed out with liquid crystal display devices: images displayed by a liquid crystal display device have low contrast (short dynamic range) as compared to images displayed by a CRT display device due to its display method. In view of this, technological development has been actively conducted in recent years for quality improvement in images displayed by liquid crystal display devices.

Japanese Patent Application Publication, Tokukai, No. 2002-99250, for example, discloses a liquid crystal display device in which the luminance of illumination light from a backlight unit is controlled for individual regions of the backlight unit in accordance with a display image so that the contrast (dynamic range) of the image is increased. The liquid crystal display device includes a liquid crystal panel and a backlight unit having a plurality of illumination regions. The liquid crystal display device further includes: backlight controlling means for controlling the luminance of illumination light from each illumination region of the backlight unit in accordance with a display image signal; and image signal controlling means for (i) converting the display image signal on the basis of data on the luminance of illumination light from each illumination region of the backlight unit, and for (ii) supplying an input image signal obtained through the conversion, into the liquid crystal panel.

The control of the luminance of illumination light from the backlight unit in accordance with a display image signal allows for (i) an increase in the luminance of illumination light emitted to a display region of the entire screen, the region displaying an image having a large bright portion, and, in contrast, (ii) a decrease in the luminance of illumination light emitted to a display region of the entire screen, the region displaying an image having a large dark portion. This consequently allows for an increase in the contrast of the entire screen. However, since the luminance of illumination light is adjusted for each illumination region, the luminance of the display image will be different from one illumination region to another if the display image signal with its original tone is supplied into the liquid crystal panel. In view of this, the input image signal is converted on the basis of the data on the luminance (i.e., of the luminance of illumination light) for each illumination region, and the input image signal thus converted is supplied into the liquid crystal panel. This makes it possible to obtain an adequate display image that is free from a luminance gap among the individual illumination regions.

Japanese Patent Application Publication, Tokukai, No. 2002-99250 discloses, as a backlight unit having a plurality of illumination regions, a backlight unit including multiple kinds of light-emitting elements, the multiple kinds having light emission principles that are different from one another.

FIGS. 13A and 13B illustrate an arrangement of the liquid crystal display device disclosed in the patent application publication discussed above. FIG. 13A is an exploded perspective view illustrating the arrangement of the liquid crystal display device 10. FIG. 13B is a cross-sectional view partially illustrating an arrangement of the backlight unit 12. As illustrated in FIGS. 13A and 13B, the liquid crystal display device 10 includes the liquid crystal panel 11 and the backlight unit 12. The backlight unit 12 has a direct structure in which a plurality of cold-cathode tubes 13 and a plurality of white LEDs 14 are arranged in a plane. The individual illumination regions of the backlight unit 12 are separated from one another by partition walls 15 that are opaque and that also serve as reflective plates. The cold-cathode tubes 13 are provided so as to extend through the partition walls 15. The white LEDs 14 are provided underneath the cold-cathode tubes 13.

Regarding how the two light sources (the cold-cathode tubes 13, the white LEDs 14) emit light, the cold-cathode tubes 13 emit light at a constant level with use of an inverter circuit, whereas the emission intensity of the white LEDs 14 is controlled by the backlight controlling means for each illumination region. When only the cold-cathode tubes 13, which emit light at a constant level, are turned on in the backlight unit 12, the liquid crystal panel 11 displays an image having a luminance of up to 50 (cd/m²). For a display region that displays an image having a luminance in excess of the above, a white LED 14 is turned on in the corresponding illumination region of the backlight unit. An image having a luminance of up to 750 (cd/m²) is displayed in such a display region.

Regarding naturally existing object colors, there is generally a correlation between brightness (lightness) and density or vividness (saturation). This correlation is quantitatively determined by use of color charts such as “Munsell Color Cascade” and “Pointer's Color” (see “The Gamut of Real Surface Colours” (COLOR research and application; Volume 5, Number 3, 145-155, Fall 1980).

For example, according to Munsell color charts of FIGS. 5A through 5C, the object colors have low saturation and are therefore achromatic in a high lightness display region and in a low lightness display region, while they have high saturation in a middle lightness display region.

According to “Pointer's Color”, object colors fall within the chromaticity range shown in a CIE chromaticity diagram of FIG. 6. With respect to the relationship between relative luminance and saturation of the object colors, it is clear from FIGS. 7A through 7F, in which the maximum luminance corresponds to 100%, that the object colors have low saturation in a display region having an extremely low luminance and in a display region having an extremely high luminance, while they have high saturation in a middle luminance display region, in a manner similar to the above.

In view of this, the above characteristic of the relationship between lightness and saturation of the object colors needs to be considered in designing a liquid crystal display device so that the liquid crystal display device has further improved display quality. In other words, further improvement in display quality requires capability to display an image having a high saturation when the display image is relatively dark (specifically, when the display image has a relative luminance in a range from 5% to 20% or thereabout).

However, according to the above liquid crystal display device 10, the backlight unit is controlled only for improvement in the luminance (lightness) of an image, and therefore is not controlled for improvement in the vividness (saturation) of an image.

### SUMMARY OF THE INVENTION

In view of the above problems, preferred embodiments of the present invention provide a liquid crystal display device in which its backlight unit is controlled for improvement in the lightness and saturation of display images so that its display quality is further improved.

A liquid crystal display device according to a preferred embodiment of the present invention includes: a liquid crystal display panel arranged to perform a color display; and a light source including: at least two kinds of light-emitting elements each having, during its emission, a different color difference between a white point and a primary color point in an image displayed on the liquid crystal display panel; and a light source control section arranged to select a kind of light-emitting element to turn on out of the at least two kinds of light-emitting elements so that the color difference of an image displayed on the liquid crystal display panel are smaller while the image has higher lightness.

The liquid crystal display device according to a preferred embodiment of the present invention includes the light source including at least two kinds of light-emitting elements different from each other in color difference between a white point and each primary color point. The color difference between a white point and each primary color point is represented by the distance between the respective coordinate points of a white chromaticity point (white point) and each primary chromaticity point (primary color point) of red, green, blue and the like, in an image (display image) displayed on the liquid crystal display panel when the at least two kinds of the light-emitting elements are individually turned on. The above phrase “at least two kinds of light-emitting elements different from each other in color difference” indicates that when the at least two kinds of the light-emitting elements are individually turned on, the color differences in the respective images (display images) displayed on the liquid crystal display panel are different.

In a preferred embodiment of the present invention, light-emitting elements having a larger color difference refer to those having a color difference between (i) each primary color point of R, G, B and the like and (ii) a white point, the color difference being larger than that of other light-emitting elements. In other words, such light-emitting elements having a larger color difference refer to those having a sum of color differences, the sum being larger than that of other light-emitting elements. Further, the light-emitting elements having a larger color difference can also be referred to as those having a larger color reproduction range (range of chromaticity reproducible by a display image).

The liquid crystal display device according to a preferred embodiment of the present invention also includes the light source control section arranged to select one of the at least two kinds of the light-emitting elements to emit light, so that the color difference of an image displayed on the liquid crystal display panel, capable of carrying out a color display, is smaller when the image has a higher lightness. In other words, the light source control section is capable of controlling how the light-emitting elements emit light so that the kind(s) of the light-emitting elements which are turned on when a display image has a lightness less than a threshold level is different from the kind(s) of the light-emitting elements which are turned on when a display image has a lightness not less than the threshold level.

According to the above arrangement, the light source includes the light-emitting elements different from each other in the color difference. In the case of displaying an image having a high saturation, this allows for displaying of an image having a higher saturation by turning on the kind of light-emitting elements having a larger color difference. In addition, the light source control section selects a kind(s) of the light-emitting elements to emit light so that the color difference of a display image is smaller when the display image has a higher lightness. In the case of displaying a bright image requiring no high saturation, this allows emphasis to be placed on an increase in the luminance of the light source. In contrast, in the case of displaying a relatively dark image that requires an image display with higher saturation because the corresponding object colors have high saturation, the light source control section selects which kind(s) of the light-emitting elements to turn on so that the color difference of the image is larger. This allows a more vivid image to be displayed. This consequently allows the luminance of the light source to be controlled in conformity with characteristics of the relationship between lightness and saturation of the object colors, thereby allowing for achievement of a liquid crystal display device having an improved display quality.

The liquid crystal display device according to a preferred embodiment of the present invention may preferably be arranged such that the light source control section (i) selects more kinds of light-emitting elements to turn on out of said at least two kinds of light-emitting elements, and (ii) selects more kinds of light-emitting elements in order of increasing the color difference, as an image displayed on the liquid crystal display panel has higher lightness.

The relationship between lightness and saturation of the object colors is characterized in that an object color with a relatively low lightness has a high saturation, while an object color with a higher lightness has a lower saturation. In view of this, in the case of displaying a relatively dark image, such an image is desirably displayed with a high saturation. In contrast, in the case of displaying a bright image, such an image requires no high saturation.

The above arrangement allows the luminance of the light source to be higher by turning on many kinds of the light-emitting elements including those having a large color difference and those having a small color difference, in the case of displaying a bright image requiring no high saturation. In contrast, in the case of displaying a relatively dark image that requires an image display with higher saturation because the corresponding object colors have high saturation, the above arrangement allows for displaying of an image by turning on only the light-emitting elements having a larger color difference. This consequently allows the luminance of the light source to be controlled in conformity with the characteristics of the relationship between lightness and saturation of the object colors, thereby allowing for achievement of a liquid crystal display device having an improved display quality.

The light-emitting elements having a larger color difference can also be referred to as those having a larger color reproduction range (range of chromaticity reproducible by a display image). Therefore, the liquid crystal display device according to a preferred embodiment of the present invention may also be arranged such that the light source control section, in response to a higher lightness of a display image, selects more of the at least two kinds of the light-emitting elements to emit light, in such a manner that the at least two kinds of the light-emitting elements are selected in descending order of the color reproduction range to emit light.

The liquid crystal display device according to a preferred embodiment of the present invention may preferably be arranged such that the at least two kinds of light-emitting elements have higher luminous efficiency with respect to power consumption as their color differences are smaller.

According to the above arrangement, a given luminance is attainable with low power consumption, as compared to the case of a backlight unit only including the light-emitting elements having the largest color difference. This allows for a reduction in power consumption by the liquid crystal display device.

Specifically, the above arrangement allows an image that has a high lightness and therefore requires no high saturation to be displayed with use of light-emitting elements that have a small color reproduction range but have a high luminous efficiency per power consumption. This allows for achievement of high luminance with low power consumption, as compared to the case of using only light-emitting elements having a large color difference. This consequently allows for cost cutting.

The liquid crystal display device according to a preferred embodiment of the present invention may preferably be arranged such that the at least two kinds of light-emitting elements have higher luminous efficiency with respect to price as their color differences are smaller.

According to the above arrangement, a given luminance is attainable with low costs, as compared to the case of a backlight unit only including the light-emitting elements having the largest color difference. This allows for a reduction in the price of the liquid crystal display device.

Specifically, the above arrangement allows an image that has a high lightness and therefore requires no high saturation to be displayed with use of light-emitting elements that have a small color reproduction range but have a high luminous efficiency per price. This allows for achievement of high luminance with low costs, as compared to the case of using only light-emitting elements having a large color difference. This consequently allows for cost cutting.

The liquid crystal display device according to a preferred embodiment of the present invention may preferably be arranged such that the light source further includes a luminance determining section for determining luminance of the light source in accordance with a tone value of an image source signal for displaying an image on the liquid crystal display panel.

The above arrangement allows the luminance of the light source to be determined in accordance with the tone value of an image source signal supplied into the liquid crystal display device. This allows, for example, the luminance of irradiation light from the light source to be adjusted so that the luminance increases with increase in the tone value. This allows a dark display image to be darker, and also allows a bright display image to be brighter, thereby allowing for displaying of an image with increased contrast.

The liquid crystal display device according to a preferred embodiment of the present invention may preferably further include a tone converting section arranged to convert a tone value of an input image signal to be supplied into the liquid crystal display panel, in accordance with the luminance of the light source, the luminance being determined by the luminance determining section.

The above arrangement allows the tone value of an input image signal to be converted in accordance with the determined luminance of the light source. Thus, when the luminance of irradiation light from the light source has been set lower than necessary, the above arrangement allows the tone value of the input image signal to be converted to a higher tone value, thereby causing the liquid crystal display panel to display an image with the tone value thus converted.

This allows a better image to be consequently displayed by the liquid crystal display device. In the case of, for example, a display image signal for a dark image, the above arrangement prevents the liquid crystal display device from consequently displaying an image that is darker than necessary because the luminance of irradiation light from the light source is set low and the display image signal for the dark image is supplied directly into the liquid crystal panel.

The liquid crystal display device according to a preferred embodiment of the present invention may preferably be arranged such that the light source has a plurality of divisional luminous regions serving as a light-emitting section; and the light source control section selects a kind of light-emitting element to turn on out of the at least two kinds of light-emitting elements so that the color difference in images to be displayed in divisional display regions of the liquid crystal display panel are smaller when the images have higher lightness in the divisional display regions, the divisional display regions corresponding to the plurality of divisional luminous regions, respectively.

The above arrangement allows the luminance of irradiation light from each divisional luminous region of the backlight unit to be controlled in accordance with the brightness of an image displayed in the corresponding divisional display region of the liquid crystal display panel. This allows an image having a high saturation to be displayed in a divisional display region for a dark image, and also allows an image having a low saturation to be displayed in a divisional display region for a bright image. This in turn allows for displaying of an image having bright portions and dark portions mixed with each other, the image having a high saturation in each divisional display region for a dark portion.

The liquid crystal display device according to a preferred embodiment of the present invention may preferably be arranged such that the liquid crystal display panel has divisional display regions corresponding to the plurality of divisional luminous regions, respectively; and the light source further includes a luminance determining section arranged to determine luminance of the plurality of divisional luminous regions in accordance with tone values of image source signals for images to be displayed in the plurality of divisional display regions, respectively.

The above arrangement allows the luminance of each divisional luminous region of the light source to be determined in accordance with the tone value of an image source signal for the corresponding divisional display region. This allows, for example, the luminance of irradiation light from the light source to be adjusted for each of the divisional luminous regions corresponding to the divisional display regions, so that the luminance increases with increase in the tone value. This allows a dark region to be darker, and also allows a bright region to be brighter, thereby allowing for displaying of an image with increased contrast for the entire screen.

The liquid crystal display device according to a preferred embodiment of the present invention may preferably further include a tone converting section arranged to convert the tone values of input image signals to be supplied into the plurality of divisional display regions of the liquid crystal display panel, in accordance with the luminance of the light source in the plurality of divisional luminous regions, respectively, the luminance being determined by the luminance determining section.

The above arrangement allows the tone value of an input image signal to be converted in accordance with the determined luminance of the light source. Thus, when the luminance of irradiation light from the light source has been set lower than necessary, the above arrangement allows the tone value of the input image signal to be converted to a higher tone value, thereby causing the liquid crystal display panel to display an image with the tone value thus converted. This allows a better image to be consequently displayed by the liquid crystal display device.

The liquid crystal display device according to a preferred embodiment of the present invention may preferably be arranged such that the light source includes: first light-emitting elements; and second light-emitting elements each having a color difference smaller than a color difference of each of the first light-emitting elements; and the first light-emitting elements are made up of a red light-emitting diode, a green light-emitting diode, and a blue light-emitting diode, and the second light-emitting elements are made up of white light-emitting diodes.

The above arrangement allows the first light-emitting elements to be made up of red, green, and blue light-emitting diodes (LEDs), and also allows the second light-emitting elements to be made up of white light-emitting diodes (LEDs). This allows the first light-emitting elements to have a color difference larger than the color difference of the second light-emitting elements, and also allows the second light-emitting elements to have a luminous efficiency higher than the luminous efficiency of the first light-emitting elements. This consequently allows the backlight unit to be controlled for improvement of lightness and saturation of a display image, thereby allowing for cost cutting.

The liquid crystal display device according to a preferred embodiment of the present invention may preferably be arranged such that the liquid crystal display panel includes color filters of three primary colors of red, green, and blue.

The above arrangement allows the colors of lights from the first light-emitting elements included in the light source to be covered by the colors of the color filters. This allows a display image to have a higher saturation.

The liquid crystal display device according to a preferred embodiment of the present invention may preferably be arranged such that 0.184≦L1 (G)/L12 (W)<1 is satisfied, where L1 (G) represents maximum luminance of green color in an image displayed on the liquid crystal display panel while only the first light-emitting elements are turned on, and L12 (W) represents maximum luminance of white color in an image displayed on the liquid crystal display panel while the first and second light-emitting elements are turned on.

The object color of green has its highest saturation at a relative luminance of about 18.4%. The saturation decreases as the luminance increases above about 18.4%. The above arrangement allows the maximum luminance L1 of green in an image displayed on the liquid crystal display panel to be over about 18.4% when only the first light-emitting elements are turned on. This makes it possible to obtain a display image having a green that sufficiently reproduces the object color of green.

The liquid crystal display device according to a preferred embodiment of the present invention may preferably be arranged such that 0.113≦L1 (R)/L12 (W)<1 is satisfied, where L1 (R) represents maximum luminance of red color in an image displayed on the liquid crystal display panel while only the first light-emitting elements are turned on, and L12 (W) represents maximum luminance of white color in an image displayed on the liquid crystal display panel while the first and second light-emitting elements are turned on.

The object color of red has its highest saturation at a relative luminance of about 11.3%. The saturation decreases as the luminance increases above about 11.3%. The above arrangement allows the red in an image displayed on the liquid crystal display panel to be over about 11.3% when only the first light-emitting elements are turned on. This makes it possible to obtain a display image having a red that sufficiently reproduces the object color of red.

Additional elements, features, characteristics, steps, advantages and strengths of the present invention will be made clear by the description below. Further, the advantages of the present invention will be evident from the following explanation in reference to the drawings.

### BRIEF DESCRIPTION OF THE DRAWINGS

FIG. 1 is a block diagram illustrating an arrangement of a liquid crystal display device in accordance with a preferred embodiment of the present invention.

FIG. 2 is a cross-sectional view illustrating an arrangement of a backlight unit included in the liquid crystal display device illustrated in FIG. 1.

FIG. 3 is a plan view illustrating a position of each light-emitting element in the backlight unit illustrated in FIG. 2.

FIG. 4 is a chromaticity diagram illustrating a white point (•), primary color points (▪; the respective chromaticities of R, G, and B), and a color reproduction range (region defined by the solid lines connecting the respective primary color points of R, G, and B) in an image displayed on a liquid crystal panel when RGB-LEDs are turned on in the liquid crystal display device of the present preferred embodiment, as well as a range of object colors at each relative luminance.

FIG. 5A is a Munsell color chart showing a relationship between lightness and saturation of red.

FIG. 5B is a Munsell color chart showing a relationship between lightness and saturation of green.

FIG. 5C is a Munsell color chart showing a relationship between lightness and saturation of blue.

FIG. 6 is a CIE chromaticity diagram indicating object colors by white dots (∘).

FIG. 7A is a CIE chromaticity diagram indicating a range of object colors at a relative luminance of about 1.9% with white dots (∘).

FIG. 7B is a CIE chromaticity diagram indicating a range of object colors at a relative luminance of about 6.2% with white dots (∘).

FIG. 7C is a CIE chromaticity diagram indicating a range of object colors at a relative luminance of about 11.3% with white dots (∘).

FIG. 7D is a CIE chromaticity diagram indicating a range of object colors at a relative luminance of about 18.4% with white dots (∘).

FIG. 7E is a CIE chromaticity diagram indicating a range of object colors at a relative luminance of about 34.1% with white dots (∘).

FIG. 7F is a CIE chromaticity diagram indicating a range of object colors at a relative luminance of about 76.3% with white dots (∘).

FIG. 8 is a chromaticity diagram concerning the liquid crystal display device of the present preferred embodiment, the diagram illustrating (i) the white point (•), the primary color points (▪; respective chromaticities of R, G, and B), and the color reproduction range (region defined by the solid lines connecting the respective primary color points of R, G, and B) in an image displayed on the liquid crystal panel when the RGB-LEDs are turned on, and (ii) the white point (•), primary color points (Δ; respective chromaticities of R, G, and B), and a color reproduction range (region defined by the broken lines connecting the respective primary color points of R′, G′, and B′) in an image displayed on the liquid crystal panel when white LEDs are turned on.

FIG. 9 is a graph illustrating respective emission spectra of the RGB-LEDs and the white LEDs and a transmission of color filters.

FIG. 10 is a block diagram illustrating an arrangement of a liquid crystal display device in accordance with another preferred embodiment of the present invention.

FIG. 11 is a cross-sectional view illustrating an arrangement of a backlight unit included in the liquid crystal display device illustrated in FIG. 10.

FIG. 12 is a plan view illustrating a position of each light-emitting element in the backlight unit illustrated in FIG. 11.

FIG. 13A is an exploded perspective view illustrating an arrangement of a conventional liquid crystal display device.

FIG. 13B is a cross-sectional view partially illustrating an arrangement of a backlight unit illustrated in FIG. 13A.

### DETAILED DESCRIPTION OF THE PREFERRED EMBODIMENTS

Preferred embodiments of the present invention are described below with reference to the attached drawings.

### First Preferred Embodiment

A first preferred embodiment describes a liquid crystal display device including a light source and a backlight control section (light source control section). The light source includes two kinds of light-emitting elements, the two kinds being different from each other in color difference between a white point and each primary color point. The backlight control section selects which kind(s) of the light-emitting elements to turn on, so that the color difference of a display image is smaller when the image has a higher lightness.

The liquid crystal display device according to a preferred embodiment of the present embodiment sets luminance of irradiation light from a backlight unit in accordance with a display image signal inputted, and, in accordance with the display image signal and the luminance of irradiation light from the backlight unit, generates an input image signal to be supplied into a liquid crystal panel. The above display image signal refers to a signal (image source signal) used for displaying an image by the liquid crystal display device, and specifically includes a television signal and a video signal, for example.

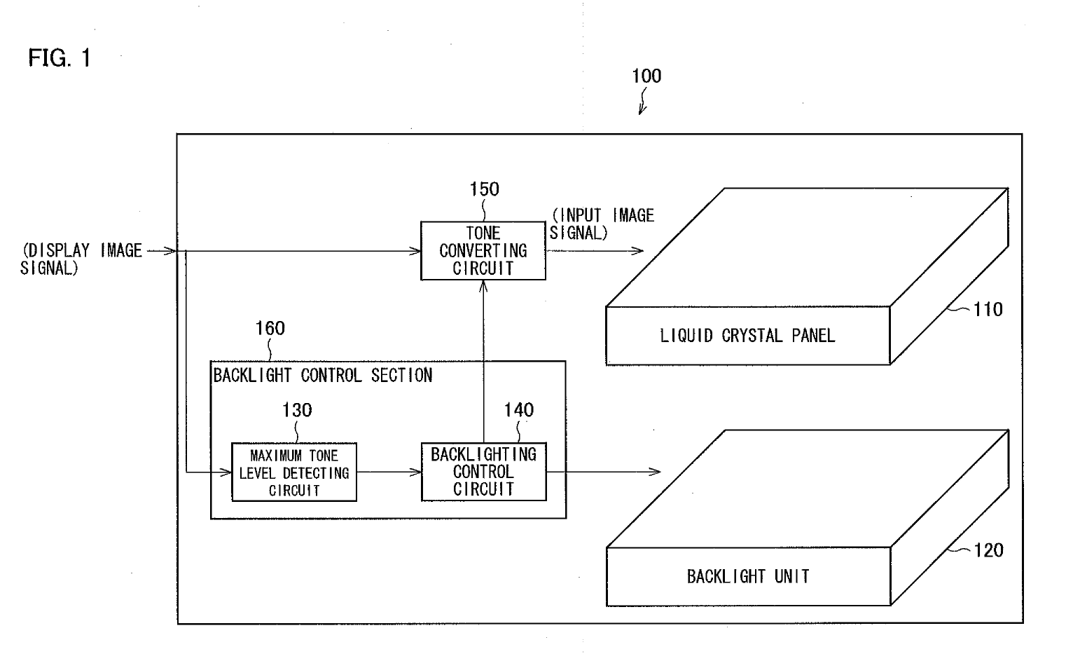

FIG. 1 is a block diagram illustrating an arrangement of main components of the liquid crystal display device 100 of the present preferred embodiment. As illustrated in FIG. 1, the liquid crystal display device 100 includes: a liquid crystal panel (liquid crystal display panel) 110 including color filters of the three primary colors of red (R), green (G), and blue (B); and a backlight unit (light source; light-emitting section) 120. The liquid crystal panel 110 displays an image by receiving illumination light from the backlight unit 120 and controlling the transmittance of the illumination light from the backlight unit 120 for each pixel in response to an input image signal inputted.

The backlight unit 120 is a direct backlight unit including: a large number of RGB-LEDs (first light-emitting elements) and a large number of white LEDs (second light-emitting elements) arranged in order; and an optical sheet that preferably includes a diffusion plate, a prism sheet and the like, and that is provided above the LEDs. The RGB-LEDs refer to light-emitting elements made up of light-emitting diodes (red LED (R-LED), green LED (G-LED), blue LED (B-LED)) each of which emits light having one of the primary colors (red, green, blue). The light-emitting diodes of each color may be light-emitting diodes that are generally used as a light source for a liquid crystal display device.

The liquid crystal panel 110 may be any liquid crystal panel that is generally used as a display panel for a liquid crystal display device, provided that the liquid crystal panel is capable of displaying color images. Note that such a liquid crystal panel preferably includes color filters for displaying color images, the color filters having colors identical to the colors of lights emitted by the light-emitting elements included in the backlight unit 120.

As illustrated in FIG. 1, the liquid crystal display device 100 includes a backlight control section (light source control section) 160 that selects how the light-emitting elements included in the backlight unit 120 emit light, in accordance with a display image signal (image source signal) used for displaying an image on the liquid crystal panel 110.

In a general liquid crystal display device, the luminance of illumination light from its backlight unit is constant. Thus, a display image signal is supplied directly into the liquid crystal panel. In contrast, preferred embodiments of the present invention allow for a change in how the light-emitting elements emit light, in accordance with a display image signal, thereby changing the luminance of irradiation light from the backlight unit. In the case of, for example, a display image signal for a dark image (i.e., in the case of a display image having a low lightness), if such a display image signal for the dark image were supplied directly into the liquid crystal panel while the luminance of irradiation light from the backlight unit is set to be low, the liquid crystal display device would end up displaying an image that is darker than necessary. In view of this, the liquid crystal panel is desirably supplied with an input image signal that is generated so that the tone of an image to be displayed is shifted higher in compensation for the lowered luminance of irradiation light from the backlight unit. This allows the liquid crystal display device to consequently display a better image (i.e., an image faithfully corresponding to the image represented by the display image signal).

For the above purpose, the liquid crystal display device 100 includes a tone converting circuit (tone converting section) 150 that generates an input image signal by converting the tone value of the display image signal in accordance with a change in the luminance of irradiation light from the backlight unit 120, and that supplies the input image signal into the liquid crystal panel.

The backlight control section 160 includes a maximum tone level detecting circuit 130 and a backlighting control circuit (luminance determining section) 140.

The maximum tone level detecting circuit 130 detects the maximum tone level of a display image signal used for displaying an image on the liquid crystal panel 110, and supplies data on the maximum tone level into the backlighting control circuit 140. The backlighting control circuit 140 determines luminance of irradiation light from the backlight unit 120 in accordance with the maximum tone level detected by the maximum tone level detecting circuit 130.

Specifically, the backlighting control circuit 140 sets high the luminance of illumination light from the backlight unit 120 when the liquid crystal display device 100 displays an image having a high maximum tone level (i.e., a bright image having a high lightness). In contrast, the backlighting control circuit 140 sets the luminance of irradiation light from the backlight unit 120 to be when the liquid crystal display device 100 displays an image having a low maximum tone level (i.e., a dark image having a low lightness).

The tone converting circuit 150 compares (i) the display image signal for an image to be displayed by the liquid crystal display device 100 with (ii) the luminance of illumination light from the backlight unit 120, the luminance having been controlled by the backlighting control circuit 140, and then generates an input image signal to be supplied into the liquid crystal panel 110.

Note that control sections for the liquid crystal display panel and control sections for the backlight unit in the liquid crystal display device 100, not described above, may have arrangements that are adopted in control sections of a conventionally known liquid crystal display device, and that the description of such control sections is therefore omitted.

The following description deals in detail with how the luminance of illumination light from the backlight unit 120 is controlled by the backlighting control circuit 140.

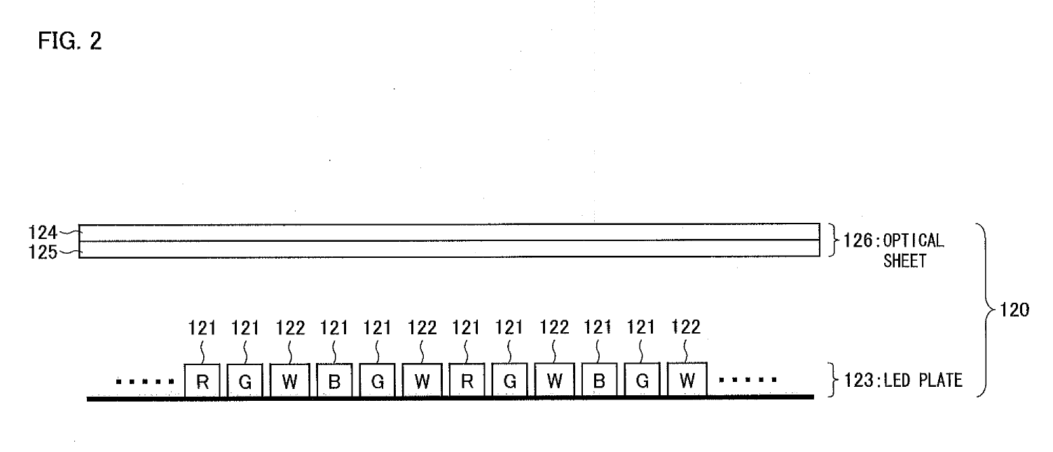

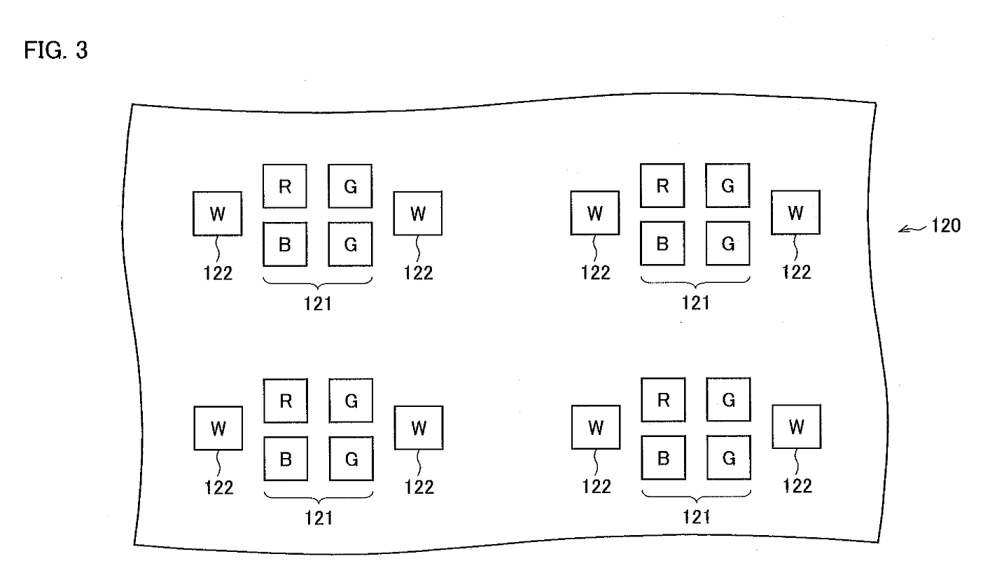

FIG. 2 is a cross-sectional view schematically illustrating the backlight unit 120. FIG. 3 is a plan view illustrating how the individual light-emitting elements are arranged in the backlight unit 120. The backlight unit 120 includes two kinds of light-emitting elements, the two kinds being different from each other in color difference between a white point and each primary color point. Specifically, the backlight unit 120 includes: RGB-LEDs 121 which serve as the first light-emitting elements and the color difference of which is larger; and white LEDs (W) 122 which serve as the second light-emitting elements and the color difference of which is smaller.

As illustrated in FIG. 2, the backlight unit 120 further includes an optical sheet 126 that is formed of a laminate of a diffusion plate 124, a prism sheet 125 and the like, and that is provided above an LED plate (light-emitting element) 123, which is made up of the RGB-LEDs 121 and the white LEDs 122 arranged in order.

As illustrated in FIG. 3, the RGB-LEDs 121 and the white LEDs 122 in the backlight unit 120 are arranged in units, each including one R-LED, two G-LEDs, one B-LED, and two white LEDs, so as to form the LED plate 123.

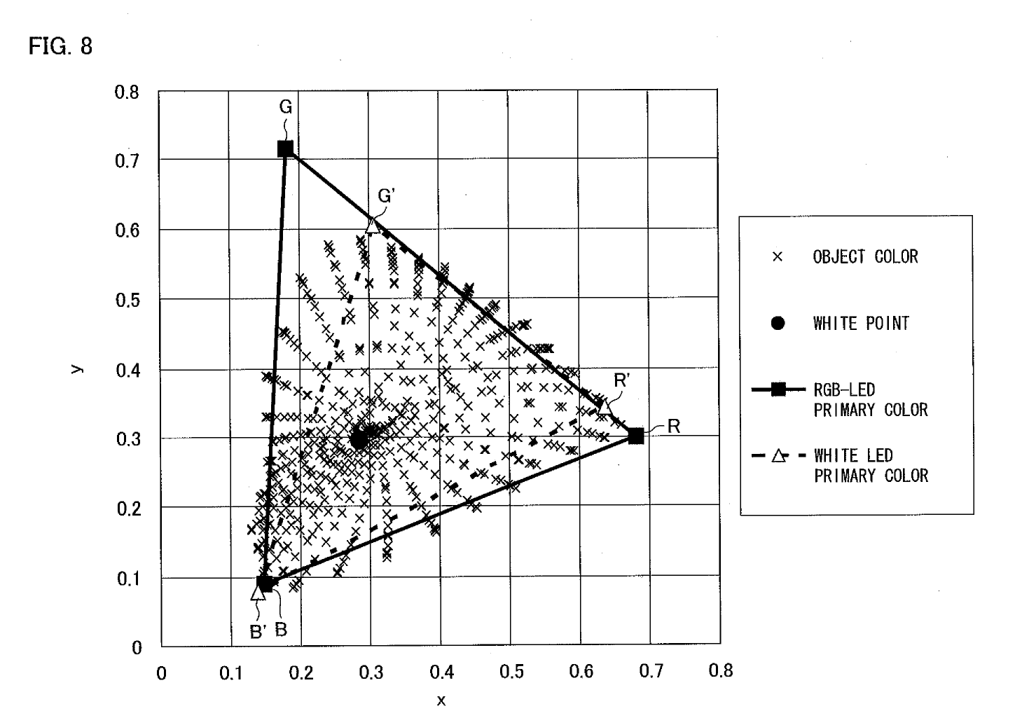

The following description deals with the color difference with reference to FIG. 8. FIG. 8 is a chromaticity diagram (chromaticity coordinate chart).

In FIG. 8, the black dot (•) represents a white chromaticity point, i.e., a white point, in an image displayed by the liquid crystal display device. Further, the black squares (▪) in FIG. 8 each represent one of chromaticity points (primary color points) R, G, and B of red, green, and blue in an image displayed on the liquid crystal panel with use of irradiation light from the RGB-LEDs, while the white triangles (Δ (white triangle)) each represent one of chromaticity points (primary color points) R′, G′, and B′ of red, green, and blue in an image displayed on the liquid crystal panel with use of irradiation light from the white LEDs.

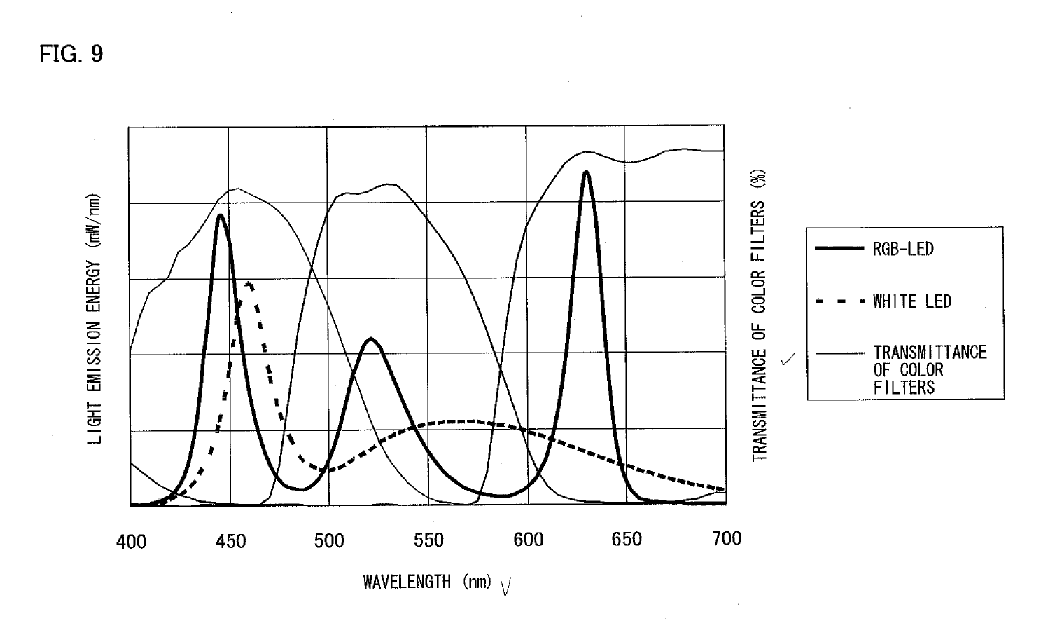

FIG. 9 shows the respective emission spectra of the RGB-LEDs and the white LEDs, and the spectral transmittance of the color filters of the liquid crystal panel.

The chromaticity points (R, G, B) of red, green, and blue in the image displayed on the liquid crystal panel with use of irradiation light from the RGB-LEDs are determined based on the relationship between the emission spectrum of the RGB-LEDs and the spectral transmittance of the color filters of the liquid crystal panel.

Similarly, the chromaticity points (R′, G′, B′) of red, green, and blue in the image displayed on the liquid crystal panel with use of irradiation light from the white LEDs are determined based on the relationship between the emission spectrum of the white LEDs and the spectral transmittance of the color filters of the liquid crystal panel.

The chromaticity points of red, green, and blue, determined as above for each of the RGB-LEDs and the white LEDs, define a triangle when connected to one another with lines. The triangle represents a color reproduction range for either the RGB-LEDs or the white LEDs.

A color difference ΔE is represented by the distance between the respective chromaticity coordinate points of each primary color point and the white point, and is expressed by a value defined by the formula (A) below. This indicates that the larger the color difference ΔE, the larger the distance between the white point and each primary color point and the higher the color saturation.

$$color difference AE = \sqrt{\begin{matrix}{( \begin{matrix}x primarycolorpoint - \\ x whitepoint\end{matrix} )}^{2} + \\ {( \begin{matrix}y primarycolorpoint - \\ y whitepoint\end{matrix} )}^{2}\end{matrix}} \qquad ( A )$$

(where x primary color point represents the x-coordinate of each primary color point; x white point represents the x-coordinate of the white point; y primary color point represents the y-coordinate of each primary color point; and y white point represents the y-coordinate of the white point)

In Table 1, each of the chromaticity points of FIG. 8 is quantified. Table 1 also shows color reproduction ranges relative to the NTSC standard.

TABLE 1

| | | | | color | color reproduction |
|---|---|---|---|---|---|
| | | | | difference | range (relative to |
| | | x | Y | (ΔE) | NTSC) |
| white point | | 0.285 | 0.296 | — | — |
| RGB-LED | R | 0.680 | 0.299 | 0.395 | 103.2% |
| | G | 0.181 | 0.716 | 0.433 | |
| | B | 0.148 | 0.090 | 0.247 | |
| white LED | R | 0.637 | 0.343 | 0.355 | 69.0% |
| | G | 0.306 | 0.606 | 0.311 | |
| | B | 0.139 | 0.078 | 0.262 | |

In various preferred embodiments of the present invention, light-emitting elements having a larger color difference refer to those having a color difference between (i) each primary color point of R, G, B and the like, and (ii) a white point, the color difference being larger than that of other light-emitting elements. In other words, such light-emitting elements having a larger color difference refer to those having a sum of color differences between the individual primary color points and the white point, the sum being larger than that of other light-emitting elements. Further, the light-emitting elements having a larger color difference can also be referred to as those having a larger color reproduction range (range of chromaticity reproducible by a display image).

The following description deals with a principle of control of lighting by the light-emitting elements, the control being performed in the backlight unit 120 of the present preferred embodiment.

Regarding naturally existing object colors, there is generally a correlation between brightness (lightness) and density or vividness (saturation). This correlation is quantitatively determined by use of color charts such as “Munsell Color Cascade” and “Pointer's Color” (See, “The Gamut of Real Surface Colours” (COLOR research and application; Volume 5, Number 3, 145-155, Fall 1980)).

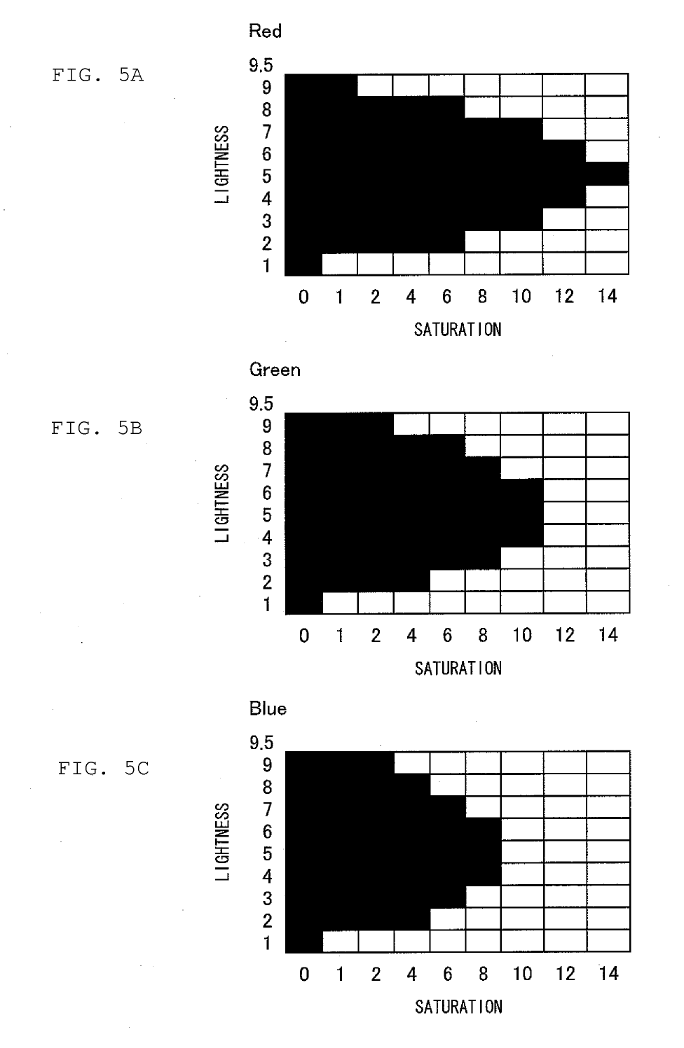

For example, according to Munsell color charts of FIGS. 5 (a) through 5 (c), the object colors have low saturation and are therefore achromatic in a high lightness display region and in a low lightness display region, while they have high saturation in a middle lightness display region. Specifically, each of red (R; see FIG. 5 (a)), green (G; see FIG. 5 (b)), and blue (B; see FIG. 5 (c)) has its highest saturation in the vicinity of 5 in lightness.

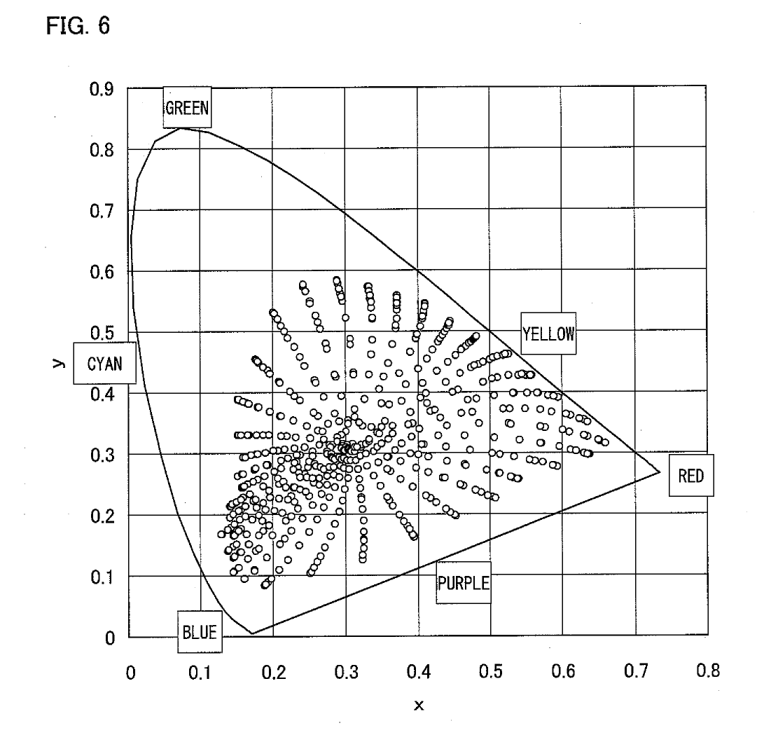

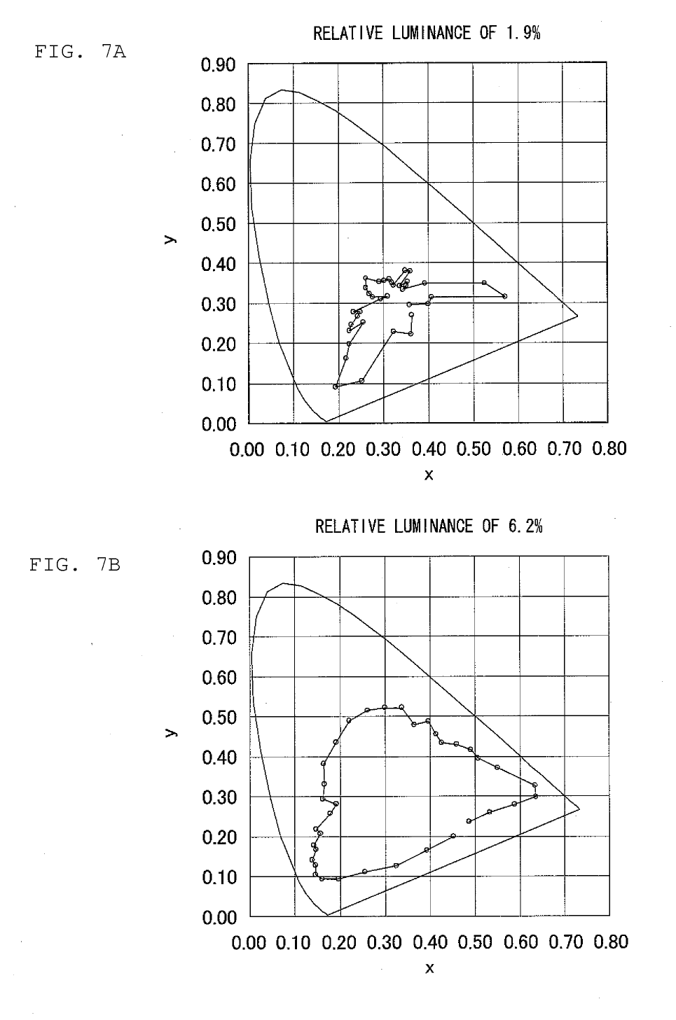

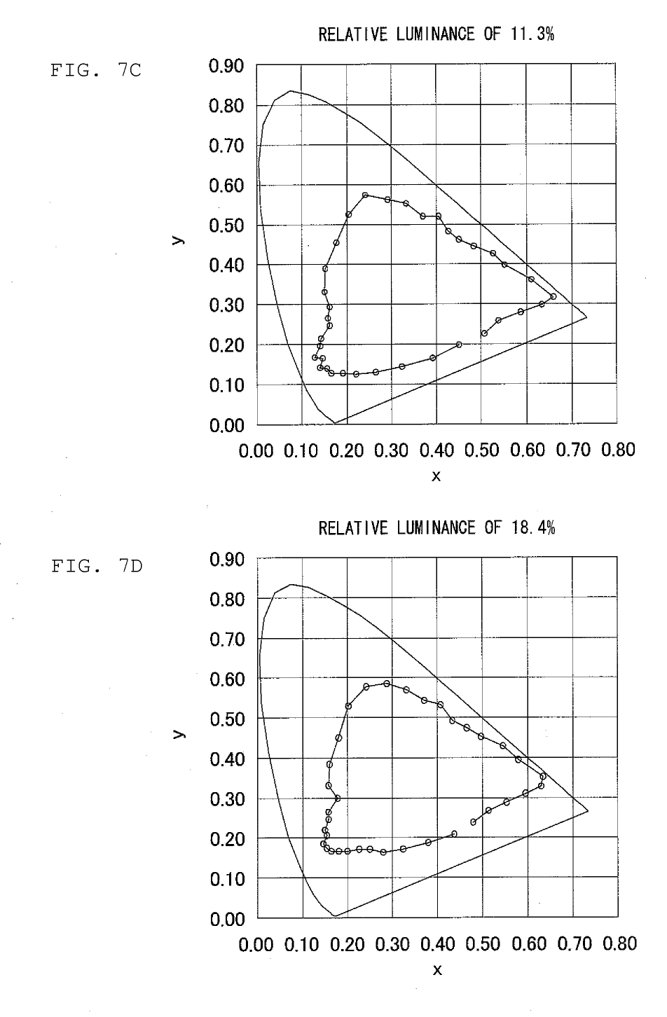

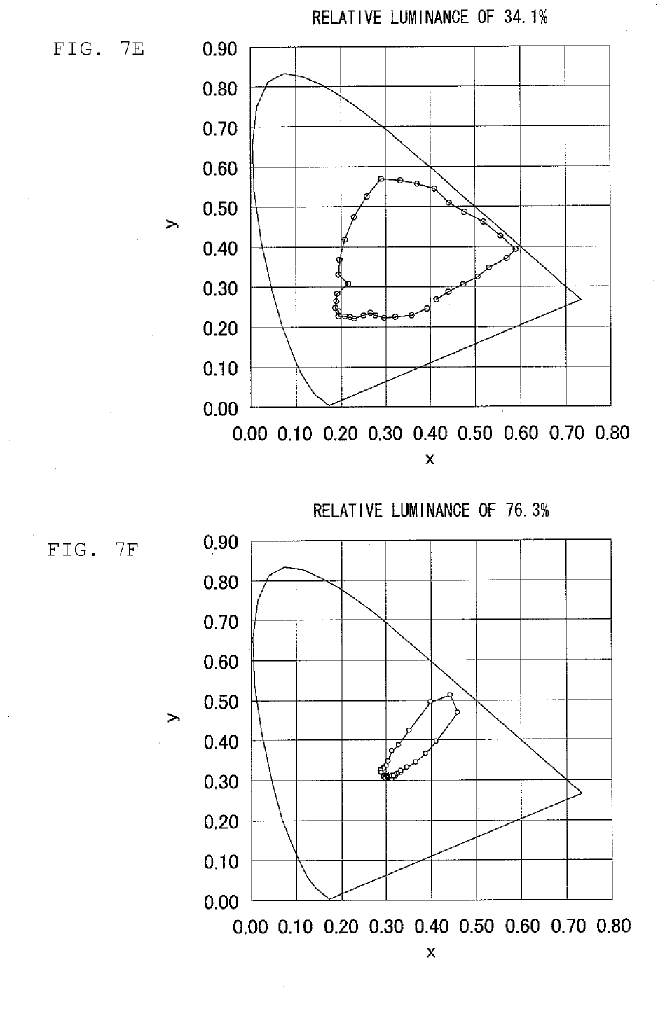

According to “Pointer's Color”, object colors fall within the chromaticity range shown in a CIE chromaticity diagram of FIG. 6. It is supposed that the region of FIG. 6 in which the white dots (∘) lie corresponds to the entire range of the object colors, and that no color (no chromaticity) in the other region naturally exists. Further, FIG. 6 shows the location of each color in the chromaticity diagram, and it is supposed that a color has a higher saturation at a location closer to a portion of the solid line, the portion corresponding to the color. With respect to the relationship between relative luminance and saturation of the object colors, it is clear from FIGS. 7A through 7F, in which the maximum luminance corresponds to 100%, that, in a manner similar to the above, the object colors have low saturation in a display region having an extremely low luminance and in a display region having an extremely high luminance, as indicated by the small areas having white dots (∘) on their periphery, while they have high saturation in a middle luminance display region, as indicated by the large areas having white dots (∘) on their periphery. To be specific about the colors, each of red, green, and blue has its highest saturation in a range of 5% to 20% in relative luminance. This is based on a result of (i) calculation of the color difference between the white point and each primary color, and (ii) examination of what percentage in luminance provides the largest color difference, with use of data presented in “The Gamut of Real Surface Colours” (COLOR research and application; Volume 5, Number 3, 145-155, Fall 1980).

In view of this, for example, in the case of a relatively dark display image that has a relative luminance in a range of 0% to 50% and that has object colors with high saturation, light-emitting elements having a large color difference between the white point and each primary color point are used as a light source despite their low luminance. This allows for displaying of an image having good color reproduction and high saturation. In contrast, in the case of a bright display image that has a relative luminance of not less than 50%, it is not disadvantageous to use, as a light source, light-emitting elements, the color difference of which is relatively small, because such a bright display image does not require high saturation. Thus, in the case of a bright display image, it is important to use, as a light source, light-emitting elements that are capable of providing relatively high luminance even through they have low color reproduction. Further, it is more cost-effective to use light-emitting elements having high luminous efficiency because a high luminance is then attainable with a fewer number of light-emitting elements.

In view of this, the liquid crystal display device of various preferred embodiments of the preset invention performs a light source control by selecting a kind(s) of the light-emitting elements to emit light, in accordance with the lightness of a display image.

The following description deals in detail with the principle of control of lighting by the light-emitting elements, by taking for example a case of using (i) RGB-LEDs made up of LEDs of red (R), green (G), and blue (B) as the first light-emitting elements, and (ii) white LEDs made up of blue LEDs and a fluorescent material as the second light-emitting elements.

FIG. 8 shows an example of a white point (•), primary color points (▪; respective chromaticities of R, G, and B), and a color reproduction range (region defined by the solid lines connecting the respective primary color points of R, G, and B) in an image displayed on the liquid crystal panel with use of irradiation light from the RGB-LEDs, in the case of displaying an image by additive color mixing of lights of red (R), green (G), and blue (B) emitted through the color filters of the liquid crystal panel, the color filters having the three primary colors R, G, and B. FIG. 8 further shows an example of the white point (•), primary color points (Δ; respective chromaticities of R, G, and B), and a color reproduction range (region defined by the broken lines connecting the respective primary color points of R′, G′, and B′) in an image displayed on the liquid crystal panel with use of irradiation light from the white LEDs, in the above case. FIG. 9 shows the respective emission spectra of the RGB-LEDs and the white LEDs and the transmittance of the color filters, obtained in the case of FIG. 8.

As illustrated in FIG. 8, when the primary color points of irradiation light from the white LEDs and those of irradiation light from the RGB-LEDs are compared, while the irradiation light from the light source of the white LEDs allows for displaying of an image having a blue with a slightly higher saturation, the irradiation light from the light source of the RGB-LEDs allows for displaying of an image having a red and a green each with a higher saturation. As regards the color reproduction ranges, each of which corresponds to the region defined by the lines connecting the primary color points of R, G, and B, it is clear that the color reproduction range of the irradiation light from the RGB-LEDs is larger. Table 1 shows specific values of (i) the color differences ΔE between the white point and the individual primary color points, and (ii) the color reproduction ranges.

As is clear from Table 1, the white LEDs have a larger color difference for blue, whereas the RGB-LEDs have a larger color difference for red and green. When the color differences are compared between the RGB-LEDs and the white LEDs, the sum of the respective color differences for the individual primary colors is larger with the RGB-LEDs. Thus, the RGB-LEDs can be regarded as light-emitting elements having a color difference larger than that of the white LEDs. This is also verifiable by the color reproduction range of the RGB-LEDs shown in Table 1, the range being larger than that of the white LEDs.

Table 2 shows an example of the luminous efficiency and luminous flux per LED of each of the RGB-LEDs and the white LEDs.

TABLE 2

| | | | | | effective |
|---|---|---|---|---|---|
| | | luminous | transmittance | effective | luminous |
| | luminous | flux per | (%) with respect | luminous | flux |
| | efficiency | LED | to liquid crystal | efficiency | per LED |
| | (lm/W) | (lm/LED) | panel | (lm/W) | (lm/LED) |
| RGB- | 35.9 | 2.76 | 4.21 | 1.5 | 0.12 |
| LED | | | | | |
| white | 54.4 | 7.15 | 3.64 | 2.0 | 0.26 |
| LED | | | | | |

According to Table 2, as compared to the case of a backlight unit only including RGB-LEDs, the white LEDs, which have a luminous efficiency higher than that of the RGB-LEDs, allow for achievement of a given luminance with low power consumption, in spite of their lower transmittance with respect to the liquid crystal panel. This allows for a reduction in power consumption by the liquid crystal display device.

Similarly, according to Table 2, as compared to the case of a backlight unit only including RGB-LEDs, the white LEDs, which have a luminous flux per LED higher than that of the RGB-LEDs, allow for a reduction in the number of LEDs, in spite of their lower transmittance with respect to the liquid crystal panel. The use of the white LEDs therefore allows for a reduction in the prices of the backlight unit and the liquid crystal display device.

The following description deals with the relationship between luminance and a color reproduction range of an image displayed by the liquid crystal display device, and also with the relationship between lightness and saturation of the object colors.

FIG. 8 shows the relationship between the object colors and each of (i) the color reproduction range of an image displayed on the liquid crystal panel with use of irradiation light from the RGB-LEDs, and (ii) the color reproduction range of an image displayed on the liquid crystal panel with the use of irradiation light from the white LEDs. According to the relationship, the image displayed with use of the irradiation light from the RGB-LEDs, although incapable of displaying some object colors, is capable of reproducing most of the object colors, whereas the image displayed with the irradiation light from the white LEDs is incapable of displaying a large number of object colors. In other words, the object colors indicated as “x” mostly lie within the color reproduction range of the RGB-LEDs (i.e., within the region defined by the solid lines connecting the primary color points (R, G, B)), whereas many of the object colors lie outside the color reproduction range of the white LEDs (i.e., outside the region defined by the broken lines connecting the primary color points (R′, G′, B′)).

With respect to the individual colors, the primary color of blue among the object colors can be displayed both in the image displayed with use of the irradiation light from the RGB-LEDs and in the image displayed with use of the irradiation light from the white LEDs, in substantially equal saturations.

The primary color of green among the object colors is reproducible in an image displayed with use of the irradiation light from the RGB-LEDs, while it cannot be displayed in an image displayed with use of the irradiation light from the white LEDs. As illustrated in FIGS. 7a through 7f, the object color of green has its highest saturation at a luminance of about 18.4%. The saturation decreases as the luminance increases above about 18.4%. When the maximum white luminance (maximum white luminance achieved when both of the RGB-LEDs and the white LEDs emit light) achieved by the liquid crystal display device is expressed as 100%, displaying of the object color of green having the luminance of about 18.4% requires the liquid crystal display device to achieve a white luminance of about 30.4% with use of irradiation light from the RGB-LEDs (see Table 3).

Table 3 shows, on the left side under the title “relative luminance”, the respective relative luminances of red, green, and blue displayed by the liquid crystal display device when the liquid crystal display device achieves the white luminance of about 30.4% with use of irradiation light from the RGB-LEDs. Table 3 also shows, on the right side under the title “relative luminance”, the respective relative luminances of red, green, and blue displayed by the liquid crystal display device when the liquid crystal display device achieves a white luminance of about 45.9% with use of illumination light from the RGB-LEDs. Specifically, a white having the relative luminance of about 30.4% is displayed by additive color mixing of the red, the green, and the blue having relative luminances of about 7.5%, about 18.4%, and about 4.8%, respectively. Similarly, a white having the relative luminance of about 45.9% is displayed by additive color mixing of the red, the green, and the blue having relative luminances of about 11.3%, about 27.7%, and about 7.2%, respectively. The values shown in Table 3 are obtained when the RGB-LEDs and the color filters of FIG. 9 are used. The respective percentages of red, green, and blue that together provide white vary according to the light source and color filters to be used.

TABLE 3

| | |
|---|---|
| color displayed by | |
| liquid crystal | |
| display device | relative luminance |

| | | |
|---|---|---|
| red | 7.5% | 11.3% |
| green | 18.4% | 27.7% |
| blue | 4.8% | 7.2% |
| white luminance | 30.4% | 45.9% |

When the white luminance of the liquid crystal display device is increased beyond about 30.4% by turning on the white LEDs in addition to the RGB-LEDs so that a green having a luminance of more than about 18.4% is displayed, since the relative luminance of the G-LEDs increases beyond about 18.4%, the saturation of the green decreases. However, the object color of green also has its saturation that decreases as the luminance increases beyond about 18.4%. This indicates that the liquid crystal display device is capable of sufficiently displaying the object color of green.

Thus, in order for the object color of green to be sufficiently displayed, the following formula is desirably satisfied:

0.184≦L1(G)/L12(W)<1,

where L1 (G) represents the maximum luminance of green in an image displayed on the liquid crystal display panel when only the first light-emitting elements (RGB-LEDs) are turned on, and L12 (W) represents the maximum luminance of white in an image displayed on the liquid crystal display panel when the first and second light-emitting elements are turned on.

The primary color of red among the object colors is also reproducible in an image displayed with use of the irradiation light from the RGB-LEDs, while it cannot be displayed in an image displayed with use of the irradiation light from the white LEDs. As illustrated in FIGS. 7A through 7F, the object color of red has its highest saturation at the luminance of about 11.3%. The saturation decreases as the luminance increases above about 11.3%. When the maximum white luminance achieved by the liquid crystal display device is expressed as 100%, displaying of the object color of red having the luminance of about 11.3% requires the liquid crystal display device to achieve the white luminance of about 45.9% with use of irradiation light from the RGB-LEDs (see Table 3).

When the white luminance of the liquid crystal display device is increased beyond about 45.9% by turning on the white LEDs in addition to the RGB-LEDs so that a red having a luminance of more than about 11.3% is displayed, since the relative luminance of the R-LEDs increases beyond about 11.3%, the saturation of the red decreases. However, the object color of red also has its saturation that decreases as the luminance increases beyond about 11.3%. This indicates that the liquid crystal display device is capable of sufficiently displaying the object color of red.

Thus, in order for the object color of red to be sufficiently displayed, the following formula is desirably satisfied:

0.113≦L1(R)/L12(W)<1,

where L1 (R) represents the maximum luminance of red in an image displayed on the liquid crystal display panel when only the first light-emitting elements (RGB-LEDs) are turned on, and L12 (W) represents the maximum luminance of white in an image displayed on the liquid crystal display panel when the first and second light-emitting elements are turned on.

With reference to Table 4, the following description deals with the number, luminance, and power consumption of each kind of the LEDs included in the backlight unit 120 of the present preferred embodiment. Table 4 also lists for comparison the number, luminance, and power consumption of LEDs included in a backlight unit of a liquid crystal display device, the backlight unit only including RGB-LEDs.

TABLE 4

| | liquid crystal display | | | liquid crystal |
|---|---|---|---|---|
| | devices 100, 200 | | | display device |
| | RGB-LED | white LED | | only including |
| | light | light | | RGB-LEDs as |
| | source | source | total | light source |
| luminance of | 217 nt | 242 nt | 459 nt | 459 nt |
| liquid crystal | | | | |
| display device | | | | |
| number of LEDs | 1344 | 672 | 2016 | 2849 |
| power | 103 W | 88 W | 191 W | 219 W |
| consumption | | | | |

As listed in Table 4, the backlight unit 120 of the present preferred embodiment preferably includes in total 1344 RGB-LEDs (i.e., 336 R-LEDs, 672 G-LEDs, and 336 B-LEDs) and 672 white LEDs, for example.

Assuming that turning on all the RGB-LEDs in the backlight unit 120 of the above arrangement results in the power consumption of about 103 (W), the luminous flux of the RGB-LEDs is about 3709 (lm); the luminance of the backlight unit 120 is about 5142 (nt); the transmittance with respect to the liquid crystal panel 110 is about 4.21%; and the luminance of the liquid crystal display device 100 is about 217 (nt). On the other hand, assuming that turning on all the white LEDs results in the power consumption of about 88 (w), the luminous flux of the white LEDs is about 4805 (lm); the luminance of the backlight unit 120 is about 6662 (nt); the transmittance with respect to the liquid crystal panel 110 is about 3.64%; and the luminance of the liquid crystal display device 100 is about 242 (nt).

Therefore, when all the RGB-LEDs and the white LEDs are turned on, the power consumption is about 191 (W), and the luminance of the liquid crystal display device is about 459 (nt). Assuming that the maximum white luminance of the liquid crystal display device 100 is expressed as 100%, about 47.3% of the white luminance of the liquid crystal display device 100 is derived from the irradiation light from the RGB-LEDs, while about 52.7% of the white luminance of the liquid crystal display device 100 is derived from the irradiation light from the white LEDs, for example.

When the liquid crystal display device 100 displays a relatively dark image, only the RGB-LEDs in the backlight unit 120 are turned on. In contrast, when the liquid crystal display device 100 displays a relatively bright image, the white LEDs in the backlight unit 120 are turned on in addition to the RGB-LEDs. This allows for displaying of an image that conforms to the relationship between brightness and saturation of the object colors.

The following description deals in detail with (i) how the luminance of irradiation light from the backlight unit 120 is controlled by the backlighting control circuit 140 in accordance with a maximum tone level detected by the maximum tone level detecting circuit 130, and also with (ii) how an input image signal to be supplied into the liquid crystal panel 110 is generated by the tone converting circuit 150.

First, the backlighting control circuit 140 determines which of the ranges (1) and (2) below corresponds to the value of the maximum tone level S of a display image signal supplied into the liquid crystal display device 100, the level having been detected by the maximum tone level detecting circuit 130. Then the backlighting control circuit 140 sets, using the equations below, luminance RGB of irradiation light from the RGB-LEDs and luminance W of irradiation light from the white LEDs of the backlight unit 120.

(1) 0≦(S/Sₘₐₓ)γ≦0.472 (i.e., when the lightness of a display image has a value not more than the threshold value)

The backlighting control circuit 140 determines the luminance of irradiation light from each kind of the light-emitting elements, using the following equations:

RGB=RGBₘₐₓ×(S/Sₘₐₓ)γ/0.427

W=0 (Equations 1-1)

In this case, as indicated in the above equations, the luminance is controlled only with use of the RGB-LEDs, with the white LEDs remaining off.

(2) 0.472<(S/Sₘₐₓ)γ≦1 (i.e., when the lightness of a display image has a value more than the threshold value)

The backlighting control circuit 140 determines the luminance of irradiation light from each kind of the light-emitting elements, using the following equations:

RGB=RGBₘₐₓ

W=Wₘₐₓ×((S/Sₘₐₓ)γ−0.427)/0.573 (Equations 1-2)

In this case, the luminance is controlled by a change in the luminance of the white LEDs, with the RGB-LEDs emitting light at the maximum luminance.

The following lists what the symbols in the above equations represent.

RGBₘₐₓ; maximum luminance of irradiation light from the RGB-LEDs of the backlight unit 120 (the luminance being about 5142 (nt), for example, in the present preferred embodiment)

RGB; luminance of irradiation light from the RGB-LEDs of the backlight unit 120

Wₘₐₓ; maximum luminance of irradiation light from the white LEDs of the backlight unit 120 (the luminance being about 6662 (nt), for example, in the present preferred embodiment)

W; luminance of irradiation light from the white LEDs of the backlight unit 120

Sₘₐₓ; maximum tone level of a display image signal

S; maximum tone level of the display image signal supplied into the liquid crystal display device 100

γ; γ coefficient (being 2.2 in the present preferred embodiment)

With respect to the above determination concerning the ranges (1) and (2), in the case of, for example, Sₘₐₓ representing 256 tone levels (8-bit tone), the threshold value of S is specifically 182 tone levels, and in the case of Sₘₐₓ representing 1024 tone levels (10-bit tone), the threshold value of S is specifically 728 tone levels.

Next, the tone converting circuit 150 generates, using the equation below, an input image signal to be supplied into the liquid crystal panel 110, on the basis of the luminances of the irradiation light from the backlight unit, the luminances being defined as above.

s*(p,q)=s(p,q)×(((T_{rgb}·RGBₘₐₓ+T_{w}·Wₘₐₓ)/(T_{rgb}·RGB+T_{w·}W))^{1/γ}) (Equation 2)

The following lists what the symbols in the above equation represent.

s* (p, q); input image signal to be supplied into the pixel in the p-th row and the q-th column of the liquid crystal panel 110

s (p, q); display image signal to be supplied into the pixel in the p-th row and the q-th column of the liquid crystal display device 100

T_{rgb}; transmittance of the irradiation light from the RGB-LEDs with respect to the liquid crystal panel 110 (the transmittance being about 4.21%, for example, in the present preferred embodiment)

T_{w}; transmittance of the irradiation light from the white LEDs with respect to the liquid crystal panel 110 (the transmittance being about 3.64%, for example, in the present preferred embodiment)

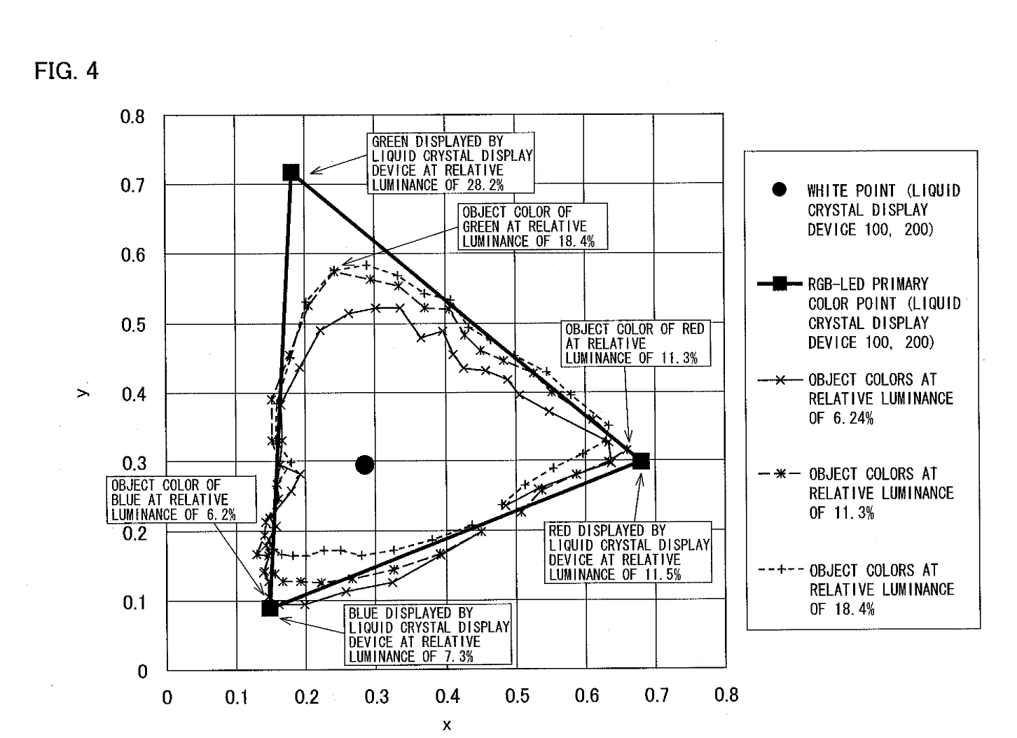

Assuming that the maximum white luminance of the liquid crystal display device 100 is expressed as 100%, the liquid crystal display device 100 provides a white luminance of about 47.2% with use of the irradiation light from the RGB-LEDs. In this case, the relative luminances of the primary colors of red, green, and blue are about 11.5%, about 28.2%, and about 7.3%, respectively. In contrast, the object colors of red, green, and blue have their highest saturations at relative luminances of about 11.3%, about 18.4%, and about 6.2%, respectively. This indicates that, as illustrated in FIG. 4, the liquid crystal display device 100 is capable of sufficiently displaying the object colors of red, green, and blue.

When the white luminance of the liquid crystal display device 100 is increased above about 47.2% by turning on the white LEDs in addition to the RGB-LEDs so that an image is displayed with the respective luminances of R, G, and B higher than the above relative luminances, the respective saturations of the R, G, and B displayed decrease. However, the object colors of R, G, and B also have their respective saturations that similarly decrease under the same conditions. This indicates that the liquid crystal display device 100 is capable of sufficiently reproducing the object colors of R, G, and B.

As shown in Table 4, a backlight unit only including RGB-LEDs requires a larger number of LEDs than the backlight unit 120 in order to achieve the luminance of about 459 (nt), and therefore consumes more power.

In contrast, according to the liquid crystal display device 100 of the present preferred embodiment, the additional use of the white LEDs allows for a reduction in power consumption and in the number of LEDs required to achieve a given maximum luminance, as compared to the case of a backlight unit only including RGB-LEDs. This is because, as shown in Table 2, the luminous efficiency and luminous flux per LED of the white LEDs are higher than those of the RGB-LEDs. Specifically, as shown in Table 4, the liquid crystal display device 100 of the present preferred embodiment allows for a reduction in power consumption to about 87% and in the number of LEDs to about 71%, in comparison with a liquid crystal display device having a backlight unit only including RGB-LEDs. In other words, the use of the white LEDs allows for achievement of a liquid crystal display device having low power consumption and requiring low costs.

As described above, the liquid crystal display device of the present preferred embodiment determines, based on the tone value of an image display signal inputted, which of the above ranges (1) and (2) the lightness of a display image falls within. When the lightness falls within the range (1) for lower lightness, only the RGB-LEDs, i.e., the first light-emitting elements, are turned on. When the lightness falls within the range (2) for higher lightness, the white LEDs, i.e., the second light-emitting elements, are turned on in addition to the first light-emitting elements. As described above, the liquid crystal display device of various preferred embodiments of the present invention selects a kind(s) of the light-emitting elements to emit light, so that the color difference of a display image is smaller when the display image has a higher lightness.

The present preferred embodiment describes, as an example, a light source formed of two kinds of light-emitting elements, i.e., RGB-LEDs and white LEDs, as a light source including at least two kinds of light-emitting elements different in color difference. However, the present invention is not limited to the above arrangement. The liquid crystal display device of the present invention may include a light source including three or more kinds of light-emitting elements different from one another in color difference.

A specific example of such three or more kinds of light-emitting elements is as follows: RGB laser diodes (first light-emitting elements); RGB-LEDs (second light-emitting elements); fluorescent tubes (third light-emitting elements); and white LEDs (fourth light-emitting elements), in descending order of color difference.

Assuming that the kind of light-emitting elements whose color difference between a white point and each primary color point is the largest are designated as first light-emitting elements, and that the kind of light-emitting elements, the color difference of which is the k-th largest, are designated as k-th light-emitting elements, the liquid crystal display device according to a preferred embodiment of the present invention may preferably be arranged such that successively more kinds of the light-emitting elements are turned on in order from the first light-emitting elements to the k-th light-emitting elements in response to increase in the brightness of an image displayed on the liquid crystal display panel. This arrangement allows luminance of irradiation light from the backlight unit to be higher in response to increased brightness of a display image. The above arrangement causes the color difference between a white point and each primary color point to be largest in an image displayed when only the first light-emitting elements are turned on, and also causes the color difference to be smaller as more kinds of the light-emitting elements are turned on in the order to the k-th light-emitting elements. In other words, a dark image is displayed with a high saturation, whereas the brighter an image is, the lower its saturation is. This allows for achievement of a liquid crystal display device capable of displaying an image in conformity with the relationship between brightness and saturation of the object colors.

Light-emitting elements, the color difference of which is large, can also be referred to as light-emitting elements capable of displaying an image having a large range of reproducible chromaticity (i.e., having a large color reproduction range). The liquid crystal display device of a preferred embodiment of the present invention allows luminance of irradiation light from the backlight unit to increase by successively turning on the light-emitting elements in the order from the first light-emitting elements to the k-th light-emitting elements, in response to a brighter image to be displayed by the liquid crystal display device. Further, the range (i.e., color reproduction range) of chromaticity reproducible in a display image is largest when only the first light-emitting elements are turned on, whereas the color reproduction range decreases as more kinds of the light-emitting elements are turned on in the order to the k-th light-emitting elements. In other words, a dark image has a large color reproduction range and therefore has a high saturation, whereas the brighter an image is, the smaller its color reproduction range is, and the lower its saturation is. This allows for achievement of a liquid crystal display device capable of displaying an image in conformity with the relationship between brightness and saturation of the object colors.

The liquid crystal display device according to a preferred embodiment of the present invention, which allows luminance of irradiation light from the backlight unit to be higher by successively turning on the light-emitting elements in the order from the first light-emitting elements to the k-th light-emitting elements when an image displayed by the liquid crystal display device is brighter, may preferably be arranged such that the light-emitting elements in the order from the k-th light-emitting elements to the first light-emitting elements (i.e., in ascending order of the color difference) are arranged in descending order of luminous efficiency per power consumption. This allows luminance of illumination light from the light source to be higher by turning on more kinds of the light-emitting elements in response to increases in the brightness of an image displayed by the liquid crystal display device. When the light-emitting elements in the order from the k-th light-emitting elements to the first light-emitting elements are arranged in descending order of the luminous efficiency per power consumption, a given luminance is attainable with low power consumption, as compared to the case of a backlight unit only including the first light-emitting elements. This allows for a reduction in power consumption by the liquid crystal display device. In other words, the liquid crystal display device is capable of achieving a high luminance with a given amount of power, as compared to a liquid crystal display device including a backlight unit that only includes the first light-emitting elements.

The liquid crystal display device according to a preferred embodiment of the present invention, which allows luminance of irradiation light from the backlight unit to be higher by successively turning on the light-emitting elements in the order from the first light-emitting elements to the k-th light-emitting elements when an image displayed by the liquid crystal display device is brighter, may preferably be arranged such that the light-emitting elements in the order from the k-th light-emitting elements to the first light-emitting elements (i.e., in ascending order of the color difference) are arranged in descending order of luminous efficiency per price. When the light-emitting elements in the order from the k-th light-emitting elements to the first light-emitting elements are arranged in descending order of luminous efficiency per price, prices of the backlight unit and the liquid crystal display device are reduced, as compared to the case of a backlight unit only including the first light-emitting elements.

### Second Preferred Embodiment

A second preferred embodiment of the present invention provides a liquid crystal display device that includes (i) a light source including two kinds of light-emitting elements different in color difference between a white point and each primary color point, the light source having a plurality of divisional luminous regions, and (ii) a backlight control section (light source control section) that selects a kind(s) of the light-emitting elements to emit light, so that the color difference of a display image for each divisional luminous region is smaller when the display image has a higher lightness.

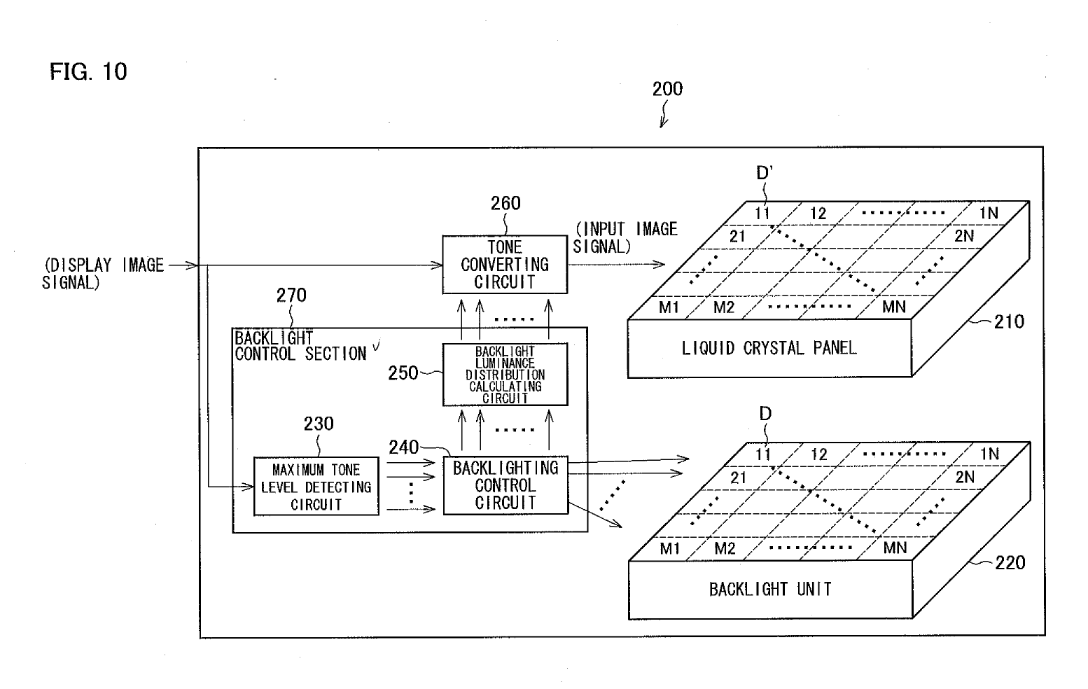

FIG. 10 is a block diagram illustrating an arrangement of main components of a liquid crystal display device 200 of the present embodiment. As illustrated in FIG. 10, the liquid crystal display device 200 includes: a liquid crystal panel (liquid crystal display panel) 210 including color filters of the three primary colors of red (R), green (G), and blue (B); and a backlight unit (light source; light-emitting section) 220. The liquid crystal panel 210 displays an image by receiving illumination light from the backlight unit 220 and controlling the transmittance of the illumination light from the backlight unit 220 for each pixel in response to an input image signal inputted.

The backlight unit 220 is a direct backlight unit including: a large number of RGB-LEDs (first light-emitting elements) and a large number of white LEDs (second light-emitting elements) arranged in order; and an optical sheet including a diffusion plate, a prism sheet and the like, and that is provided above the LEDs. The RGB-LEDs and the white LEDs described in the first preferred embodiment may be used also in the backlight unit 220. The backlight unit 220 is divided into divisional luminous regions D arranged in a matrix of M rows and N columns. The LEDs are turned on and off for each divisional luminous region.

The liquid crystal panel 210 includes pixels arranged in a matrix of P rows and Q columns. Also, the liquid crystal panel 210 can be imaginarily divided into divisional display regions D′ arranged in a matrix of M rows and N columns, the divisional display regions D′ having a one-to-one correspondence with the divisional luminous regions D of the backlight unit 220.

The liquid crystal panel 210 may be any liquid crystal panel that is generally used as a display panel for a liquid crystal display device, provided that the liquid crystal panel is capable of displaying color images. Note that such a liquid crystal panel preferably includes color filters for displaying color images, the color filters having colors identical to the colors of lights emitted by the light-emitting elements included in the backlight unit 220.

As illustrated in FIG. 10, the liquid crystal display device 200 includes a backlight control section (light source control section) 270 that selects, for each of the divisional luminous regions D, how the light-emitting elements of the backlight unit 220 emit light, in accordance with a display image signal (image source signal) in a corresponding one of the divisional display regions D′, the display image signal being used for displaying an image on the liquid crystal panel 210.

In a general liquid crystal display device, the luminance of illumination light from its backlight unit is constant. Thus, a display image signal is supplied directly into the liquid crystal panel. In contrast, various preferred embodiments of the present invention allows for a change in how the light-emitting elements emit light, in accordance with a display image signal, thereby changing the luminance of irradiation light from the backlight unit. In the case of, for example, a display image signal for a dark image in a specific divisional display region D′ (i.e., in the case of a display image having a low lightness), if such a display image signal for the dark image were supplied directly into the liquid crystal panel while the luminance of irradiation light from the backlight unit in the corresponding divisional luminous region D is set low, the liquid crystal display device would end up displaying an image that is darker than necessary. In view of this, the liquid crystal panel is desirably supplied with an input image signal that is generated so that the tone of an image to be displayed is shifted higher in compensation for the lowered luminance of irradiation light from the backlight unit. This allows the liquid crystal display device to consequently display a better image (i.e., an image faithfully corresponding to the image represented by the display image signal).

For the above purpose, the liquid crystal display device 200 includes a tone converting circuit (tone converting section) 260 that generates an input image signal by converting the tone value of the display image signal in accordance with a change in the luminance of irradiation light from the backlight unit 220, and that supplies the input image signal into the liquid crystal panel.

The backlight control section 270 includes a maximum tone level detecting circuit 230, a backlighting control circuit (luminance determining section) 240, and a backlight luminance distribution calculating circuit 250.

The maximum tone level detecting circuit 230 detects the maximum tone level of a display image signal for each of the divisional display regions D′ of the liquid crystal panel 210, and supplies data on the maximum tone level into the backlighting control circuit 240. The backlighting control circuit 240 determines luminance of illumination light from the backlight unit 220 for each of the divisional luminous regions D, in accordance with the maximum tone level for the corresponding one of the divisional display regions D′, the maximum tone level having been detected by the maximum tone level detecting circuit 230.

Specifically, for a divisional display region D′ where the liquid crystal display device 200 displays an image having a high maximum tone level (i.e., a bright image having a high lightness), the backlighting control circuit 240 sets high the luminance of irradiation light from the corresponding divisional luminous region D of the backlight unit 220. In contrast, for a divisional display region D′ where the liquid crystal display device 200 displays an image having a low maximum tone level (i.e., a dark image having a low lightness), the backlighting control circuit 240 sets low the luminance of irradiation light from the corresponding divisional luminous region of the backlight unit 220.

The backlight luminance distribution calculating circuit 250 calculates a luminance distribution of the entire backlight unit 220 from the luminance of irradiation light from each of the divisional luminous regions D of the backlight unit 220, the luminance having been controlled by the backlighting control circuit 240. The luminance distribution is so calculated as to include the influence of the spreading (i.e., cross talk) of irradiation light from a divisional luminous region over a region surrounding the intended region. The luminance distribution of the entire backlight unit 220 is calculated using the matrix of P rows and Q columns, corresponding to the pixels of the liquid crystal panel 210.

The tone converting circuit 260 compares (i) the display image signal for an image to be displayed by the liquid crystal display device 200 with (ii) the luminance distribution of the backlight unit 220, the luminance having been calculated by the backlight luminance distribution calculating circuit 250, and then generates an input image signal to be supplied into the liquid crystal panel 210.

Note that control sections for the liquid crystal display panel and control sections for the backlight unit in the liquid crystal display device 200, the control sections being not described above, may have arrangements that are adopted in control sections of a conventionally known liquid crystal display device, and that the description of such control sections is therefore omitted.

The following description deals in detail with how the luminance of illumination light from the backlight unit 220 is controlled for each divisional luminous region D.

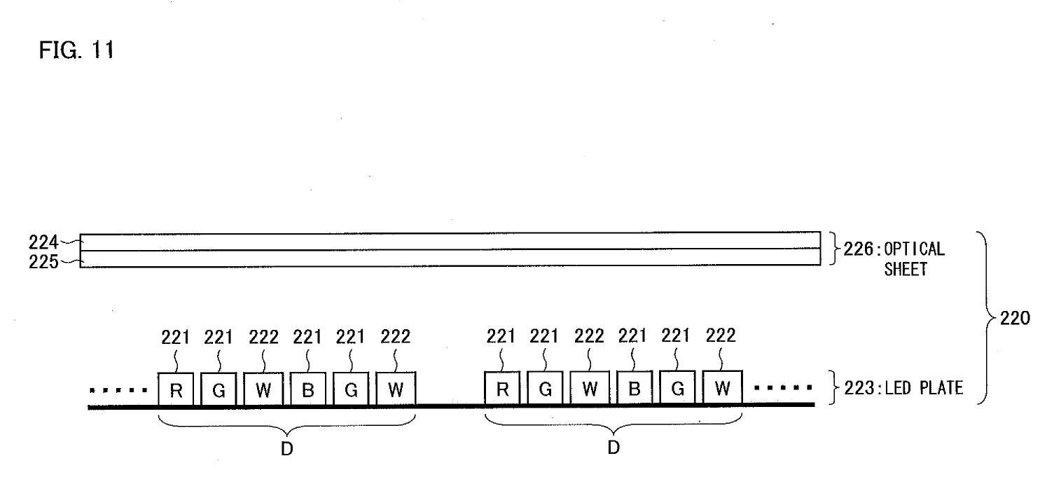

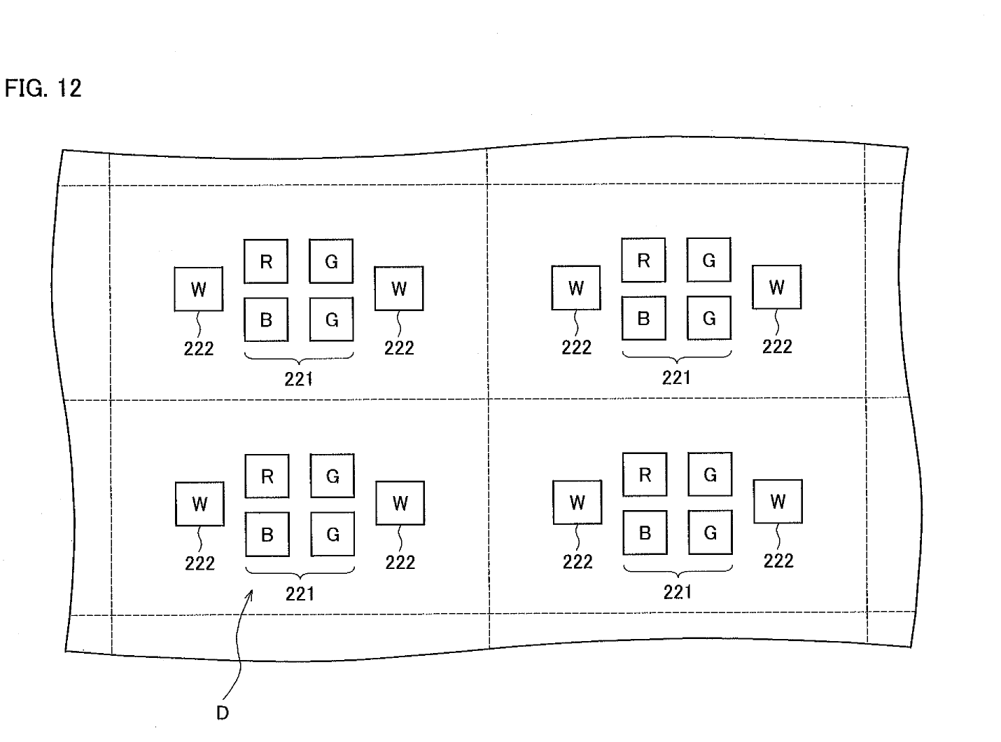

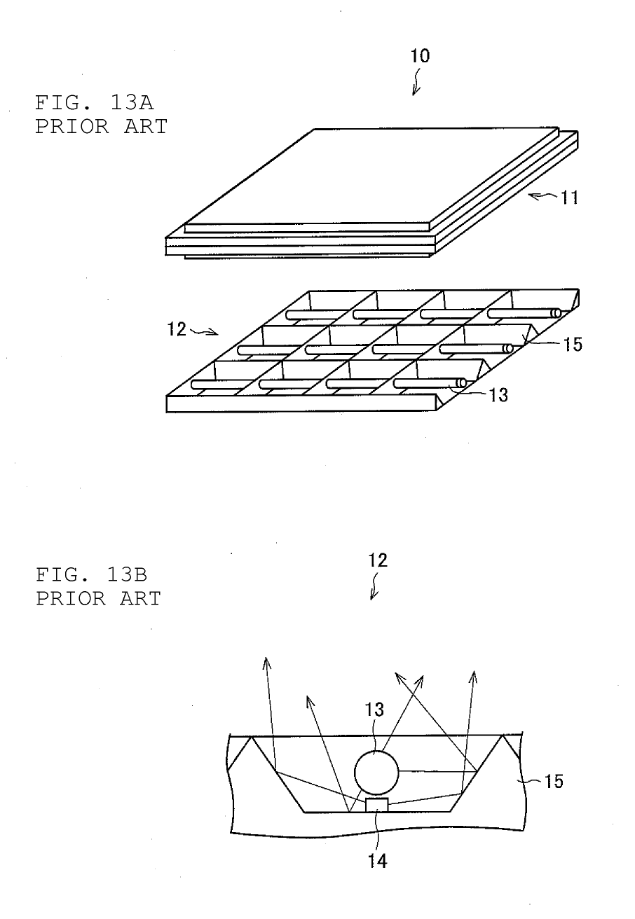

FIG. 11 is a cross-sectional view schematically illustrating the backlight unit 220. FIG. 12 is a plan view illustrating how the individual light-emitting elements are arranged in the backlight unit 220. The backlight unit 220 includes two kinds of light-emitting elements, the two kinds being different from each other in color difference between a white point and each primary color point. Specifically, the backlight unit 220 includes: RGB-LEDs 221 which serve as the first light-emitting elements and the color difference of which is larger; and white LEDs 222 which serve as the second light-emitting elements and the color difference of which is smaller.

As illustrated in FIG. 11, the backlight unit 220 further includes an optical sheet 226 that preferably includes a laminate of a diffusion plate 224, a prism sheet 225 and the like, and that is provided above an LED plate (light-emitting element) 223, which is made up of the RGB-LEDs 221 and the white LEDs 222 arranged in order.

As illustrated in FIG. 12, the RGB-LEDs 221 and the white LEDs 222 in the backlight unit 220 are closely arranged in units each including one R-LED, two G-LEDs, one B-LED, and two white LEDs, so as to define the LED plate 223. Each of the divisional luminous regions D includes a single unit described above.

The backlight unit 220 of the present preferred embodiment has divisional luminous regions that are arranged in a matrix of 14 rows and 24 columns, specifically. Therefore, the numbers of all LEDs included in the backlight unit 220 are: 336 R-LEDs; 672 G-LEDs; 336 B-LEDs; and 672 white LEDs.

Table 4 above lists the number, luminance, and power consumption of each kind of LEDs included in the backlight unit 220.

As shown in Table 4, assuming that turning on all the RGB-LEDs in the backlight unit 220 of the above arrangement results in the power consumption of about 103 (W), the luminous flux of the RGB-LEDs is about 3709 (lm); the luminance of the backlight unit 120 is about 5142 (nt); the transmittance with respect to the liquid crystal panel 210 is about 4.21%; and the luminance of the liquid crystal display device 200 is about 217 (nt), for example. On the other hand, assuming that turning on all the white LEDs results in the power consumption of about 88 (W), the luminous flux of the white LEDs is about 4805 (lm); the luminance of the backlight unit 120 is about 6662 (nt); the transmittance with respect to the liquid crystal panel 210 is about 3.64%; and the luminance of the liquid crystal display device 200 is about 242 (nt), for example.

Therefore, when all the RGB-LEDs and the white LEDs are turned on, the power consumption is about 191 (W), and the luminance of the liquid crystal display device is about 459 (nt), for example. Assuming that the maximum white luminance of the liquid crystal display device 200 is expressed as 100%, about 47.3% of the white luminance of the liquid crystal display device 200 is derived from the irradiation light from the RGB-LEDs, while about 52.7% of the white luminance of the liquid crystal display device 200 is derived from the irradiation light from the white LEDs.

For a divisional display region D′ where the liquid crystal display device 200 displays a relatively dark image, only the RGB-LEDs in the corresponding divisional luminous region D of the backlight unit 220 are turned on. In contrast, for a divisional display region D′ where the liquid crystal display device 200 displays a relatively bright image, the white LEDs in the corresponding divisional luminous region D of the backlight unit 220 are turned on in addition to the RGB-LEDs. This allows for displaying of an image that conforms to the relationship between brightness and saturation of the object colors.

The following description deals in detail with (i) how the luminance of irradiation light from each of the divisional luminous regions D of the backlight unit 220 is controlled by the backlighting control circuit 240 in accordance with a maximum tone level detected by the maximum tone level detecting circuit 230, and also with (ii) how an input image signal to be supplied into the liquid crystal panel 210 is generated by the tone converting circuit 260.

First, the backlighting control circuit 240 determines which of the ranges (1) and (2) below corresponds to the value of the maximum tone level S (m, n) of a display image signal supplied into a divisional display region D′ (m, n) of the m-th row and the n-th column of the liquid crystal display device 200, the level having been detected by the maximum tone level detecting circuit 230. Then the backlighting control circuit 240 sets, using the equations below, luminance RGB (m, n) of irradiation light from the RGB-LEDs and luminance W (m, n) of irradiation light from the white LEDs in the corresponding divisional luminous region D (m, n) of the m-th row and the n-th column of the backlight unit 220.

(1) 0<(S (m, n)/Sₘₐₓ)γ≦0.472 (i.e., when the lightness of a display image has a value not more than the threshold value)

The backlighting control circuit 240 determines the luminance of irradiation light from each kind of the light-emitting elements, using the following equations:

RGB(m,n)=RGBₘₐₓ×(S(m,n)/Sₘₐₓ)γ/0.427

W(m,n)=0 (Equations 3-1)

In this case, as indicated in the above equations, the luminance is controlled only with use of the RGB-LEDs, with the white LEDs remaining off.

(2) 0.472<(S (m, n)/Sₘₐₓ)γ≦1 (i.e., when the lightness of a display image has a value more than the threshold value)

The backlighting control circuit 240 determines the luminance of irradiation light from each kind of the light-emitting elements, using the following equations:

RGB(m,n)=RGBₘₐₓ

W(m,n)=Wₘₐₓ×((S(m,n)/Sₘₐₓ)γ−0.427)/0.573 (Equations 3-2)

In this case, the luminance is controlled by a change in the luminance of the white LEDs, with the RGB-LEDs emitting light at the maximum luminance.

The following lists what the symbols in the above equations represent.

RGBₘₐₓ; maximum luminance of illumination light from the RGB-LEDs of the backlight unit 220 (the luminance being about 5142 (nt), for example, in the present preferred embodiment)

RGB (m, n); luminance of irradiation light from the RGB-LEDs in the divisional display region D′ (m, n) of the backlight unit 220

Wₘₐₓ; maximum luminance of irradiation light from the white LEDs of the backlight unit 220 (the luminance being about 6662 (nt), for example, in the present preferred embodiment)

W (m, n); luminance of irradiation light from the white LEDs in the divisional luminance region D (m, n) of the backlight unit 220

Sₘₐₓ; maximum tone level of a display image signal

S (m, n); maximum tone level of the display image signal supplied into the divisional display region D′ (m, n) of the liquid crystal display device 200

γ; γ coefficient (being 2.2 in the present preferred embodiment)

The backlight luminance distribution calculating circuit 250 then calculates, using the equation below, a luminance distribution rgb (p, q) of the entire irradiation light from the RGB-LEDs and a luminance distribution w (p, q) of the entire irradiation light from the white LEDs, the calculation being so performed as to include the influence of cross talk among irradiation lights from the individual divisional luminous regions of the backlight unit 220.

$$\begin{matrix}Math 2 & \\ rgb ( p , q ) = {\sum }_{m} {\sum }_{n} C ( RGB ) pq ( m , n ) RGB ( m , n ) & ( Equation 4 \text{-} 1 ) \\ w ( p , q ) = {\sum }_{m} {\sum }_{n} C ( W ) pq ( m , n ) W ( m , n ) & ( Equation 4 \text{-} 2 )\end{matrix}$$

The following lists what the symbols in the above equation represent.

rgb (p, q); luminance of irradiation light from the RGB-LEDs of the backlight unit 220, the irradiation light being directed at the pixel (p, q) in the p-th row and the q-th column of the liquid crystal panel 210

C (RGB) pq (m, n); cross talk coefficient of RGB (m, n) with respect to rgb (p, q)

w (p, q); luminance of irradiation light from the white LEDs of the backlight unit 220, the irradiation light being directed at the pixel (p, q) in the p-th row and the q-th column of the liquid crystal panel 210

C (W) pq (m, n); cross talk coefficient of W (m, n) with respect to w (p, q)

The tone converting circuit 260 then generates an input image signal to be supplied into the liquid crystal panel 210, using the following equation:

s*(p,q)=s(p,q)×(((T_{rgb}·RGBₘₐₓ+T_{w}·Wₘₐₓ)/(T_{rgb}·rgb(p,q)+T_{w}·W(p,q)))^{1/γ}) (Equation 5)

The following lists what the symbols in the above equation represent.

s* (p, q); input image signal to be supplied into the pixel in the p-th row and the q-th column of the liquid crystal panel 210

s (p, q); display image signal to be supplied into the pixel in the p-th row and the q-th column of the liquid crystal display device 200

T_{rgb}; transmittance of the irradiation light from the RGB-LEDs with respect to the liquid crystal panel 210 (the transmittance being about 4.21%, for example, in the present preferred embodiment)

T_{w}; transmittance of the irradiation light from the white LEDs with respect to the liquid crystal panel 210 (the transmittance being about 3.64% in the present preferred embodiment)

Assuming that the maximum white luminance of the liquid crystal display device 200 is expressed as 100%, the liquid crystal display device 200 provides a white luminance of about 47.2% with use of the irradiation light from the RGB-LEDs. In this case, the relative luminances of the primary colors of red, green, and blue are about 11.5%, about 28.2%, and about 7.3%, respectively. In contrast, the object colors of red, green, and blue have their highest saturations at relative luminances of about 11.3%, about 18.4%, and about 6.2%, respectively. This indicates that, as illustrated in FIG. 4, the liquid crystal display device 200 is capable of sufficiently displaying the object colors of red, green, and blue.

When the white luminance of the liquid crystal display device 200 is increased above about 47.2% by turning on the white LEDs in addition to the RGB-LEDs so that an image is displayed with the respective luminances of R, G, and B higher than the above relative luminances, the respective saturations of the R, G, and B displayed decrease. However, the object colors of R, G, and B also have their respective saturations that similarly decrease under the same conditions. This indicates that the liquid crystal display device 200 is capable of sufficiently reproducing the object colors of R, G, and B.

As shown in Table 4, a backlight unit only including RGB-LEDs requires a larger number of LEDs than the backlight unit 220 in order to achieve the luminance of about 459 (nt), and therefore consumes more power.

In contrast, according to the liquid crystal display device 200 of the present preferred embodiment, the additional use of the white LEDs allows for a reduction in power consumption and in the number of LEDs required to achieve a given maximum luminance, as compared to the case of a backlight unit only including RGB-LEDs. This is because, as shown in Table 2, the luminous efficiency and luminous flux per LED of the white LEDs are higher than those of the RGB-LEDs. Specifically, as shown in Table 4, the liquid crystal display device 200 of the present preferred embodiment allows for a reduction in power consumption to about 87% and in the number of LEDs to about 71%, in comparison with a liquid crystal display device having a backlight unit only including RGB-LEDs. In other words, the use of the white LEDs allows for achievement of a liquid crystal display device having low power consumption and requiring low costs.

As described above, the liquid crystal display device of the present preferred embodiment controls the luminance of irradiation light from each divisional luminous region of the backlight unit in accordance with the brightness of an image to be displayed in the corresponding divisional display region of the liquid crystal display device. This causes a divisional display region for a dark image to display an image having a high saturation, and also causes a divisional display region for a bright image to display an image having a low saturation. This in turn allows for displaying of an image having bright portions and dark portions mixed with each other, the image having a high saturation in each divisional display region for a dark portion.

Specifically, for a divisional display region for a dark portion of a display image, only the RGB-LEDs (first light-emitting elements) of the backlight unit are turned on so that an image having a high saturation is displayed. In contrast, for a divisional display region for a bright portion of the display image, the white LEDs are turned on in addition to the RGB-LEDs so that the luminance of irradiation light from the backlight unit is high. Turning on the white LEDs lowers the saturation of an image; however, this conforms to the relationship between lightness and saturation of the object colors, and therefore poses no problem.

The present invention is not limited to the description of the preferred embodiments above, but may be altered by a skilled person within the scope of the claims. Another preferred embodiment based on a proper combination of technical features disclosed in different preferred embodiments is encompassed in the technical scope of the present invention.

The present invention may also be implemented in many other ways without departing from the above main features. The above preferred embodiments serve solely as examples in all respects. Thus, the present invention should not be narrowly interpreted within the limits of such preferred embodiments. The scope of the invention is defined in the following claims, and therefore is not limited by the specification. Further, the scope of the invention encompasses all modifications, variations, and processes that fall within an equivalent range of the scope of the claims.

The liquid crystal display device according to various preferred embodiments of the present invention allows for improvement in image quality by controlling its light source, and is therefore applicable in display apparatuses that display images, such as televisions and videocassette players.

While preferred embodiments of the present invention have been described above, it is to be understood that variations and modifications will be apparent to those skilled in the art without departing the scope and spirit of the present invention. The scope of the present invention, therefore, is to be determined solely by the following claims.

1-13. (canceled)

14. A liquid crystal display device comprising:
a liquid crystal display panel arranged to perform color display; and
a light source including:
at least two kinds of light-emitting elements each having, during emission, a different color difference between a white point and a primary color point in an image displayed on the liquid crystal display panel; and
a light source control section arranged to select from said at least two kinds of light-emitting elements a kind of light-emitting element to turn on so that the color difference of an image displayed on the liquid crystal display panel becomes smaller while the image has higher lightness.

15. The liquid crystal display device according to claim 14, wherein the light source control section is arranged to select more kinds of the light-emitting elements to turn on in order of increasing color difference, as an image displayed on the liquid crystal display panel becomes higher in lightness.

16. The liquid crystal display device according to claim 15, wherein said at least two kinds of light-emitting elements have higher luminous efficiency with respect to power consumption as color differences thereof become smaller.

17. The liquid crystal display device according to claim 15, wherein said at least two kinds of light-emitting elements have higher luminous efficiency with respect to price as color differences thereof become smaller.

18. The liquid crystal display device according to claim 14, wherein the light source includes a luminance determining section arranged to determine luminance of the light source in accordance with a tone value of an image source signal to display an image on the liquid crystal display panel.

19. The liquid crystal display device according to claim 18, further comprising a tone converting section arranged to convert a tone value of an input image signal to be supplied into the liquid crystal display panel, in accordance with the luminance of the light source, the luminance being determined by the luminance determining section.

20. The liquid crystal display device according to claim 14, wherein:
the light source has a plurality of divisional luminous regions defining a light-emitting section; and
the light source control section is arranged to select at least one of said at least two kinds of light-emitting element to turn on so that the color difference in images to be displayed in divisional display regions of the liquid crystal display panel are smaller when the images have higher lightness in the divisional display regions, the divisional display regions corresponding to the plurality of divisional luminous regions, respectively.

21. The liquid crystal display device according to claim 20, wherein:
the liquid crystal display panel has divisional display regions corresponding to the plurality of divisional luminous regions, respectively; and
the light source includes a luminance determining section arranged to determine luminance of the plurality of divisional luminous regions in accordance with tone values of image source signals for images to be displayed in the plurality of divisional display regions, respectively.

22. The liquid crystal display device according to claim 21, further comprising a tone converting section arranged to convert the tone values of input image signals to be supplied into the plurality of divisional display regions of the liquid crystal display panel, in accordance with the luminance of the light source in the plurality of divisional luminous regions, respectively, the luminance being determined by the luminance determining section.

23. The liquid crystal display device according to claim 14, wherein:
the light source includes:
second light-emitting elements each having a color difference smaller than a color difference of each of the first light-emitting elements; and
the first light-emitting elements include a red light-emitting diode, a green light-emitting diode, and a blue light-emitting diode, and the second light-emitting elements include white light-emitting diodes.

24. The liquid crystal display device according to claim 23, wherein the liquid crystal display panel includes color filters of three primary colors of red, green, and blue.

25. The liquid crystal display device according to claim 24, wherein 0.184≦L1 (G)/L12 (W)<1 is satisfied, where L1 (G) represents maximum luminance of green color in an image displayed on the liquid crystal display panel while only the first light-emitting elements are turned on, and L12 (W) represents maximum luminance of white color in an image displayed on the liquid crystal display panel while the first and second light-emitting elements are turned on.

26. The liquid crystal display device according to claim 24, wherein 0.113≦L1 (R)/L12 (W)<1 is satisfied, where L1 (R) represents maximum luminance of red color in an image displayed on the liquid crystal display panel while only the first light-emitting elements are turned on, and L12 (W) represents maximum luminance of white color in an image displayed on the liquid crystal display panel while the first and second light-emitting elements are turned on.
